(19) United States
(12) Patent Application Publication
(10) Pub. No.: US 2015/0279269 A1
(43) Pub. Date: Oct. 1, 2015

(54) DISPLAY APPARATUS AND METHOD OF DRIVING THE SAME

(71) Applicant: SAMSUNG DISPLAY CO., LTD., Yongin-City (KR)

(72) Inventors: Ryo ISHII, Yokohama (JP); Daisuke KAWAE, Yokohama (JP); Masayuki KUMETA, Yokohama (JP); Eiji KANDA, Yokohama (JP); Takeshi OKUNO, Yokohama (JP)

(21) Appl. No.: 14/668,186

(22) Filed: Mar. 25, 2015

(30) Foreign Application Priority Data
Mar. 26, 2014 (JP) 2014-064750

(51) Int. Cl. G09G 3/32

(52) U.S. Cl. CPC G09G 3/3208; G09G 3/3233

(57) ABSTRACT

A display apparatus includes a scan line driver and a data line driver. The data line driver supplies data signals to turn on or off pixel circuits connected to selected scan lines. The pixel circuits are turned on or off in sub frames. For each scan line, the sub frames are assigned in the display period based on a reference point. During a preliminary period, the scan line driver selects a scan line and the data line driving circuit supplies a data signal to the pixel circuit based on the reference point. During the display period, the scan line driver selects scan line connected to the pixel circuit in synchronization with an initiation timing of each sub frame of the display period. The data line driver supplies the data signal to the pixel circuit based on the state of the sub frame corresponding to initiation timing.

### CROSS-REFERENCE TO RELATED APPLICATION

Japanese Patent Application No. 2014-064750, filed on Mar. 26, 2014, and entitled, “Display Apparatus and Method of Driving the Same,” is incorporated by reference herein in its entirety.

### BACKGROUND

1. Field

One or more embodiments described herein relates to a display apparatus and a method for driving a display apparatus.

2. Description of the Related Art

One type of display generates images using self-emissive organic electro-luminescence elements. Such a display employs a sub frame driving method, in which a gray level of light is displayed by changing of the occupation ratio of a turn-on time of a pixel during one frame. For example, the sub frame driving method divides one frame into a plurality of sub frames and switches a light emitting element between ON and OFF states during each sub frame. As a result, a specific gray level of light is emitted by controlling the occupation ratio of a turn-on time of the pixel in one frame.

Also, in a sub frame driving method, when scanning timing shifts in time series every scan line, an image corresponding to one frame is displayed over a plurality of frames (for example, two frames). Therefore, when such a driving method is applied to, for example, a shutter-type 3D display which time-division displays an image for a right eye and an image for a left eye every frame, crosstalk occurs because the images for the right eye and left eye are mixed in one frame. Because left-eye and right-eye images are observed by both eyes of a viewer, the images may appear to be out of focus or may otherwise appear to be unclear as a 3D image.

### SUMMARY

In accordance with one or more embodiments, a display apparatus includes a plurality of pixel circuits at respective intersections of a plurality of scan lines and a plurality data lines; a scan line driving circuit to supply a scan signal to each of the scan lines to exclusively select the scan line; and a data line driving circuit to supply a data signal to the data lines to turn-on or turn-off the pixel circuits connected to a selected scan line, wherein a display period for displaying an image of one frame is divided into a plurality of sub frames, wherein the pixel circuits are to be turned on or turned off every corresponding sub frame to display an image expressed by a plurality of gray levels on a screen, wherein, for each of the scan lines, the series of sub frames is assigned in the display period using a time point in the display period as a reference point.

For each pixel circuit, during a preliminary period preset for the one frame, the scan line driving circuit is to sequentially select a scan line of the pixel circuit and the data line driving circuit is to supply the data signal to the data line of the pixel circuit based on the reference point. During the display period of the one frame, the scan line driving circuit is to select scan line connected to the pixel circuit in synchronization with an initiation timing of each sub frame of the display period, and the data line driving circuit is to supply the data signal to the data line connected to the pixel circuit based on a state of the sub frame corresponding to initiation timing. For each of the scan lines, the series of sub frames is assigned cyclically in a priority-determined order with respect to the display period using the reference point as a starting point.

A period occupied by each of the series of sub frames during the display period may be priority-weighted, and different gray levels may be displayed with respect to respective combinations of the sub frames in which the pixel circuit has a turn-on state. The preliminary period may be set to be longer than a period in which the scan line driving circuit is to exclusively select the scan lines.

For each of the scan lines, the sub frames may be assigned for the display period using different time points in the display period as the reference point. All of the pixel circuits may be turned-off during the preliminary period. When the display apparatus is to time-divisionally display an image for a left eye and an image for a right eye every frame, the preliminary period may be set within a switch period for switching the left-eye image and the right-eye image.

Luminance of the display screen in the one frame may be adjusted according to a number of the pixel circuits turned on during the display period of the one frame. The luminance of the display screen in the one frame may be adjusted according to a supply voltage supplied to the pixel circuit.

The pixel circuit may include a light emitting element; a capacitor to maintain a supplied data signal; and a switch element to be switched to one of a conductive state or a non-conductive state based on the data signal maintained at the capacitor, wherein: based on selection of the scan line by the scan line driving circuit, the supplied data signal is to be maintained at the capacitor of the pixel circuit connected to the scan line, and based on non-selection of the scan line, the switch element is switched based on the data signal maintained at the capacitor and supply of current to the light emitting element is to be controlled.

Each pixel circuit may include a light emitting element; a capacitor to maintain a supplied data signal; a switch element switched to one of a conductive state or a non-conductive state based on the data signal maintained at the capacitor; and a constant current circuit to enable a current value of the current supplied to the light emitting element to have a predetermined value, wherein: based on selection of the scan line by the scan line driving circuit, the supplied data signal is to be maintained at the capacitor of the pixel circuit connected to a corresponding scan line, and based on non-selection of the scan line, the switch element is to be switched based on the data signal maintained at the capacitor and supply of current to the light emitting element is to be directly or indirectly controlled.

The constant current circuit may be connected between the switch element and the light emitting element. The constant current circuit may include a driving transistor including a control terminal, a first terminal connected to a switch element side, and a second terminal connected to a light emitting element side; a second capacitor connected to a control terminal side of the driving transistor; and a second switch element between the control terminal and the second terminal and to switch between a conductive state and a non-conductive state, wherein: when the second switch element is in the conductive state, the control terminal and the second terminal are bypassed, and a control signal supplied from the first terminal of the driving transistor to the control terminal thereof to drive a corresponding driving transistor is to be maintained at the second capacitor, and supply of a current to the light emitting element through the driving transistor is to be directly or indirectly controlled based on the control signal maintained at the second capacitor.

During the preliminary period, the second switch element may be controlled to be in the conductive state in a period before the data line driving circuit is to supply the data signal to a corresponding one of the pixel circuits. Luminance of the display screen in the one frame may be adjusted according to the control signal maintained at the second capacitor. The pixel circuit may include a light emitting element, the display apparatus includes a detector to detect current flowing in the corresponding light emitting element during the preliminary period, and based on a detection result of the current every pixel circuit, an amount of light emission of a corresponding pixel circuit in the one frame is to be adjusted.

In accordance with one or more other embodiments, a method for driving a display apparatus includes sequentially selecting a plurality of scan lines; and supplying data signals to the selected scan lines, which are connected to corresponding pixel circuits, each of the data signals supplied to a selected scan line based on a reference point, wherein: in a display period, sequentially selecting the scan lines includes sequentially selecting the scan lines in synchronization with an initiation timing of each sub frame assigned with respect to the display period for each scan line; and supplying data signals to respective ones of the pixel circuits connected to the selected scan lines, the data signals supplied based on the state set for each sub frame in synchronization with the initiation timing.

In accordance with one or more other embodiments, an apparatus includes a scan line driver to select each of a plurality of scan lines; and a data line driver to supply data signals to data lines to turn-on or turn-off corresponding pixel circuits connected to the selected scan lines, wherein: a display period of a frame includes a plurality of sub frames, the pixel circuits are to be turned on or turned off every sub frame to display an image, for each of the scan lines, the sub frames are assigned in the display period based on a reference point, and for each pixel circuit: (a) during a preliminary period of the frame, the scan line driver circuit is to select the scan line connected to the pixel circuit and the data line driving circuit is to supply the data signal to the data line connected to the pixel circuit based on the reference point, (b) during the display period of the frame, the scan line driver is to select the scan line connected to the pixel circuit in synchronization with an initiation timing of each sub frame and the data line driver is to supply the data signal to the pixel circuit based on a state of the sub frame corresponding to the initiation timing.

### BRIEF DESCRIPTION OF THE DRAWINGS

Features will become apparent to those of skill in the art by describing in detail exemplary embodiments with reference to the attached drawings in which:

FIG. 1 illustrates an embodiment of a display;

FIG. 2 illustrates an embodiment of a pixel circuit;

FIG. 3 illustrates a driving method according to a comparative example;

FIG. 4 illustrates an embodiment of a setting sequence for driving a display;

FIG. 5 illustrates an embodiment of a setting sequence for driving a display;

FIG. 6 illustrates an embodiment for selecting a scan line;

FIG. 7 illustrates an embodiment of a method for setting scanning timing;

FIGS. 8A and 8B illustrate an embodiment of waveforms for driving a display;

FIG. 9 illustrates another embodiment for selecting a scan line;

FIG. 10 illustrates another embodiment of a display apparatus;

FIG. 11 illustrates another embodiment of a pixel circuit;

FIG. 12 illustrates another embodiment for selecting a scan line;

FIG. 13 illustrates another embodiment of a method for driving a display;

FIG. 14 illustrates a display data and light emitting state of a light emitting element corresponding to another embodiment of a pixel circuit;

FIG. 15 illustrates another embodiment of a display;

FIG. 16 illustrates another embodiment of a pixel circuit;

FIG. 17 illustrates a first state for an embodiment of detection circuit;

FIG. 18 illustrates another state for the detection circuit;

FIG. 19 illustrates another state for the detection circuit;

FIG. 20 illustrates another embodiment for selecting a scan line; and

FIG. 21 illustrates another embodiment of a method for driving a display.

### DETAILED DESCRIPTION

Example embodiments are described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art. The embodiments may be combined to form additional embodiments. Like reference numerals refer to like elements throughout.

In accordance with one embodiment, the display apparatus to be described is an organic electro-luminescence (EL) display having organic EL elements as light emitting elements. The display apparatus may be a different type of display and/or may have a different type of display elements in another embodiment. For example, the display apparatus may have inorganic EL elements that emits light based on current flow, or may be a liquid crystal display to which a sub frame driving method may be applied.

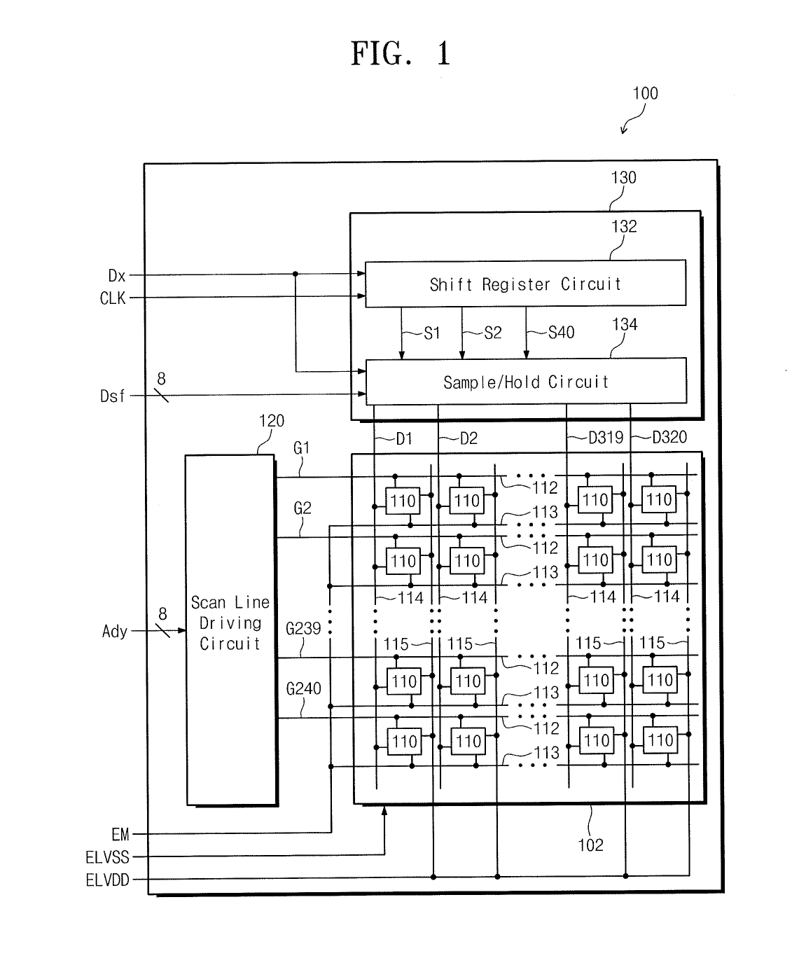

FIG. 1 illustrates an embodiment of a display apparatus 100 which includes a display unit 102, a scan line driving circuit 120, and a data line driving circuit 130. The display unit 102 includes a plurality of pixel circuits 110 and displays an image corresponding to a data signal on a display screen. The pixel circuits 110 are at respective intersections of a plurality of scan lines 112 and a plurality of data lines 114, that are orthogonal to the scan lines.

For example, the direction in which the scan lines 112 extend may be a row direction (Y direction), and the direction in which the data lines 114 extend may be a column direction (X direction). Thus, the pixel circuits 110 are disposed in a matrix shape. For illustrative purposes only, the display unit 102 has 112 scan lines arranged in the row direction (Y direction) and 320 data lines 114 are arranged in the column direction (X direction). The display unit may have a different number of scan lines and/or data lines in another embodiment.

A light emitting supply voltage ELVDD and a light emitting supply voltage ELVSS are respectively supplied, for example, from one or more control or source circuits to the display unit 102. The light emitting supply voltage ELVDD and the light emitting supply voltage ELVSS are signals for supplying current for enabling a light emitting element in the pixel circuit 110 to emit light.

The display apparatus 100 displays light of a different gray level according to an occupation ratio of a period in which a light emitting element emits light, for a switch-on period provided during one frame, as in, e.g., the sub frame driving method. The current for enabling the light emitting element in the pixel circuit 110 to emit light may be set to a value enabling the light emitting element to obtain white luminance, when the light emitting element continuously emits light during a switch-on period provided in the one frame. The light emitting supply voltage ELVDD is supplied to each pixel circuit 110 through a supply voltage line 115. The light emitting supply voltage ELVSS is supplied from a common electrode to each pixel circuit 110.

The scan line driving circuit 120 includes a kind of an address decoder that exclusively outputs an L-level scan signal to the scan line 112 corresponding to a row designated by an address signal Ady supplied from a control circuit. Scan signals supplied to first, second, third, . . . and 240th scan lines 112 are denoted by G1, G2, G3, . . . and G240, respectively. One scan signal is represented by ┌Gi┘, where i is an integer and 1≦i≦240.

The data line driving circuit 130 supplies H-level or L-level data bits as data signals to the data lines 114 of first to 320th columns. In this example, data bits supplied to the data lines 114 of first, second, third, . . . , and 320th columns are denoted by D1, D2, D3, . . . , and D320 and one of the data bits is represented by ┌Dj┘ (where j is an integer and 1≦j≦320). For example, the data line driving circuit 130 samples 8-bit display data Dsf supplied from a control circuit to supply a sampled data signal to the data line 114.

The data line driving circuit 130 includes a shift register circuit 132 and a sample/hold circuit 134. The shift register circuit 132 sequential shifts a horizontal synchronous signal Dx in synchronization with a clock signal CLK at the start of a period in which the first row scan line is selected by the address Ady supplied from a higher control circuit. In addition, the shift register circuit 132 narrows the width of a shifted signal to the half period of the clock signal CLK, and sequentially and exclusively transmits an H-level sampling signal S1, S2, S3, . . . , and S40 to the sample/hold circuit 134.

Based on the sampling signals S1 to S40 from the shift register circuit 132, the sample/hold circuit 134 sequentially selects the data lines 114 so that eight lines become one block. In addition, the sample/hold circuit 134 latches and holds the display data Dsf supplied from the control circuit, and outputs a data signal corresponding to the first row in synchronization with the horizontal synchronous signal Dx to the data lines 114 at the same time.

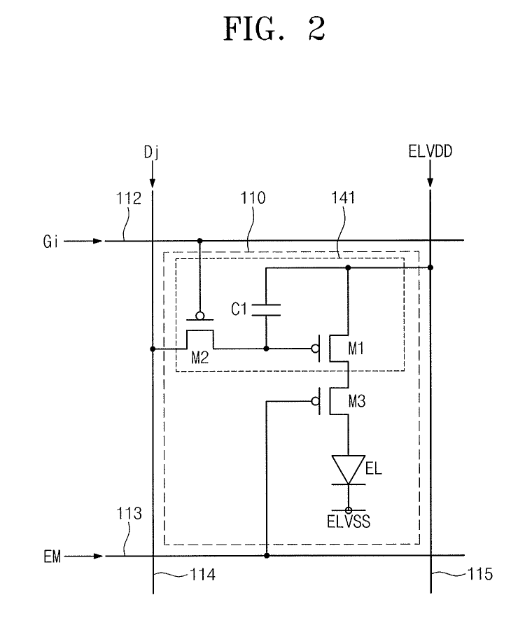

FIG. 2 illustrates an embodiment of the pixel circuit 110 at the intersection of an i-th row and a j-th column of the display unit 102 in FIG. 1. The other pixel circuits 110 in the display unit 102 may have a similar configuration.

The pixel circuit 110 includes a light emitting element EL, a first switch element M1, a second switch element M2, a third switch element M3, and a capacitor C1. The first switch element M1 is on the wiring path between the supply voltage line 115 and the anode terminal of the light emitting element EL, and is turned on or turned off according to a data bit Dj transmitted to its gate terminal through the data line 114 and the second switch M2.

The source terminal of the second switch element M2 is connected to the data line 114, and the drain terminal of the second switch element M2 is connected to the gate terminal of the first switch element M1. The second switch element M2 is turned on or turned off in response to a scan signal Gi transmitted to its gate terminal through the scan line 112.

One terminal of the capacitor C1 is connected to the gate terminal of the first switch element M1. The other terminal of the first switch element M1 is connected to the supply voltage line 115. The capacitor C1 maintains the potential of the gate terminal of the first switch element M1.

The source terminal of the third switch element M3 is connected to the drain terminal of the first switch element M1. The drain terminal of the third switch element M3 is connected to the anode terminal of the light emitting element EL. The third switch element M3 is turned on or turned off in response to a control signal EM transmitted to the gate terminal through a control signal line 113.

In this example, when the scan signal Gi transmitted from the scan line 112 becomes an L level, the second switch element M2 is turned-on and the data bit Dj transmitted from the data line 114 is transmitted to the pixel circuit 110. Also, the data bit Dj is an H-level or L-level signal. When the scan signal Gi transmitted from the scan line 112 becomes the H level, the second switch element M2 is turned-off and the data bit transmitted from the data line Dj is maintained at the capacitor C1.

In the pixel circuit 110, the first switch element M1 is selectively turned on according to the signal level of the data bit Dj transmitted from the data line 114 and maintained at the capacitor C1 so that the light emitting state of the light emitting element EL is controlled. For example, when the signal level of the data bit Dj maintained at the capacitor C1 is the H level, the first switch element M1 is turned off and a current is not supplied to the light emitting element EL. Thus, the light emitting element EL is in a non-emission state. Also, when the signal level of the data bit Dj maintained at the capacitor C1 is the L level, the first switch element M1 is turned on and the control signal EM transmitted from the control signal line 113 becomes the L-level. Thus, the third switch element M3 is turned-on.

Accordingly, a current is supplied to the light emitting element EL to cause the light emitting element EL to emit light. When the control signal EM is in the H level, the third switch element M3 is turned off. So, irrespective of the state of the first switch element M1, the light emitting element EL is in a non-emission state because current is not supplied to the light emitting element EL.

The case where the first switch element M1 is turned on may be called a “light emitting state,” e.g., a state in which the third switch element M3 is turned on to enable the light emitting element EL. The case where the first switch element M1 or the third switch element M3 is turned-off may be called a “non-emission state.”

As described previously, the display apparatus 100 displays a different a gray level of light according to an occupation ratio of a period in which a light emitting element emits light, for a switch-on period provided during one frame. For example, the display apparatus 100 divides the one frame into a switch-on period and a switch-off period and divides the switch-on period into a plurality of sub frames. In addition, the display apparatus 100 changes a level of the data bit Dj supplied to the data line 114 to have the H or L level in each sub frame, obtained through division, to control the light emitting state or non-emission state of the pixel circuit 110 (e.g., operates using a sub frame driving method). Due to such a configuration, it is possible to express different gray levels of light according to the number of sub frames which have the light emitting state in a switch-on period.

The period of one frame may be appropriately set, for example, according to the configuration of the display apparatus or to the specification of an image to be displayed. For example, when one cycle of frame frequency 60 Hz corresponds to one frame, the period of the one frame is 16.7 msec.

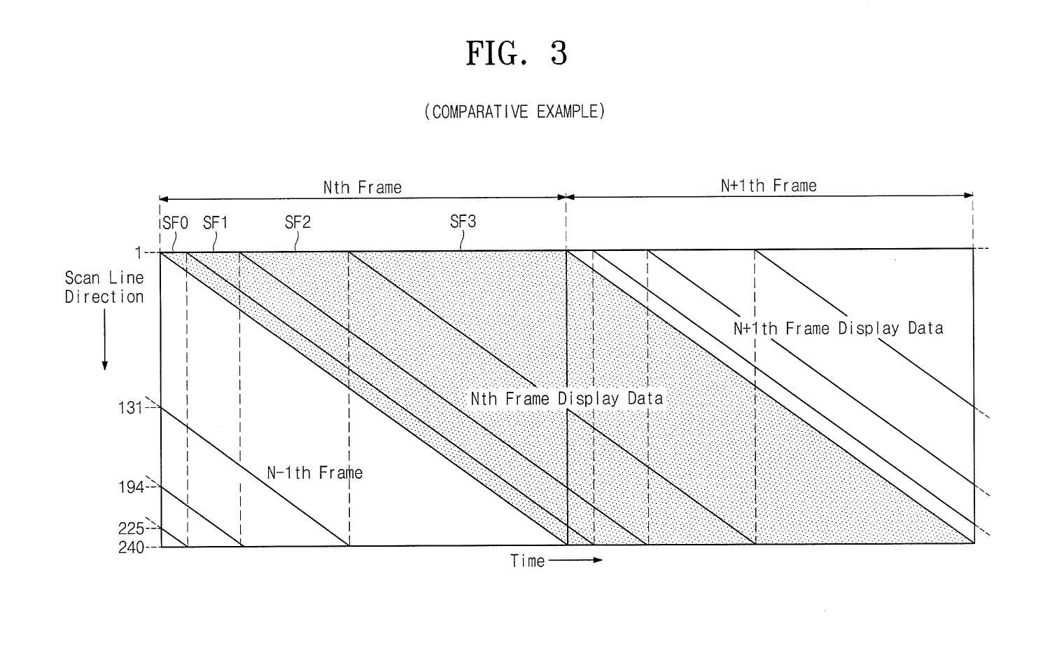

Before describing a method for driving the display, a comparative example of a driving method is described with reference to FIG. 3. The method of FIG. 3 explains selection of a scan line in a display to which a sub frame driving method is applied.

Referring to FIG. 3, the comparative example operates based on a sub frame driving method using an interlaced scan scheme, in which scanning timing on the first row scan line is applied to all scan lines, performing a sequential shift. In such a configuration, when supplying a data signal to a pixel circuit connected to a selected scan line is completed, the display according to the comparative example enables the pixel circuit connected to the selected scan line to be in a turn-on state, without waiting for supply of the data signal to a pixel circuit connected to another scan line. Therefore, the display of the comparative example may increase or maximize one horizontal period.

Also, in the comparative example, when a frame frequency is F [Hz], the number of scan lines is m [Line], and the number of sub frames is Nsf [SF], one horizontal period 1H is set based on Equation 1:

$$1 H = \frac{1}{F \times m \times Nsf} \qquad ( 1 )$$

In Equation 1, when the frame frequency F is 60 Hz, the number of scan lines m is 240 lines, and the number of sub frames Nsf is 4 SF, one horizontal period 1H is 17.4 μsec.

In the display according to the comparative example, an image of an N-th frame (where N is an integer and N≧1) is continuously displayed also in an (N+1)-th frame, for a configuration in which scanning timing shifts in time series every scan line. Thus, the display according to the comparative example displays, in the one frame, a plurality of images corresponding to another frame.

Therefore, when the above-described driving method is applied to a shutter-type 3D display apparatus, in which an N-th frame period is an image display period for a left eye and an (N+1)-th frame period is an image display period for a right eye, crosstalk occurs because the left-eye and right-eye images are mixed in one frame. As a result, each eye of the viewer sees both the left-eye and right-eye images. The 3D images seen by the viewer are therefore out of focus or otherwise unclear.

Also, an effect resulting from displaying, in one frame, a plurality of images corresponding to another frame is not limited to only the crosstalk that occurs when the driving method is applied to the shutter-type 3D display apparatus. For example, there is a technology called peak luminance control that controls luminance according to the number of pixel circuits emitting light (e.g., the number of pixel circuits representing white luminance). Even when such peak luminance control is performed, a display apparatus displays a plurality of images corresponding to another frame during the one frame, so a luminance setting corresponding to the plurality of those images is mixed. In this case, when different luminance levels are set among the plurality of images displayed during the one frame, each image may be observed by a user at a luminance level different from an actually set luminance level.

In accordance with one embodiment, a sub frame driving method uses an interlaced scan scheme. As a result, the switch-off period in which all pixel circuits are turned-off during one frame may be reduced or minimized, and only the image of a corresponding frame is displayed every frame, without the effects of crosstalk. As a result, a clear and focused image is seen by a viewer.

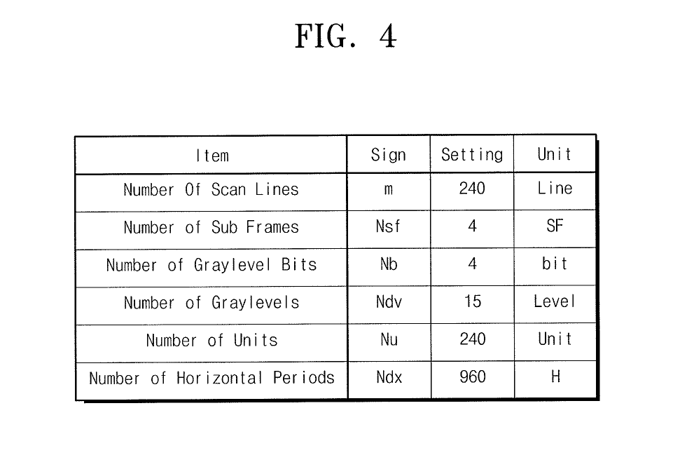

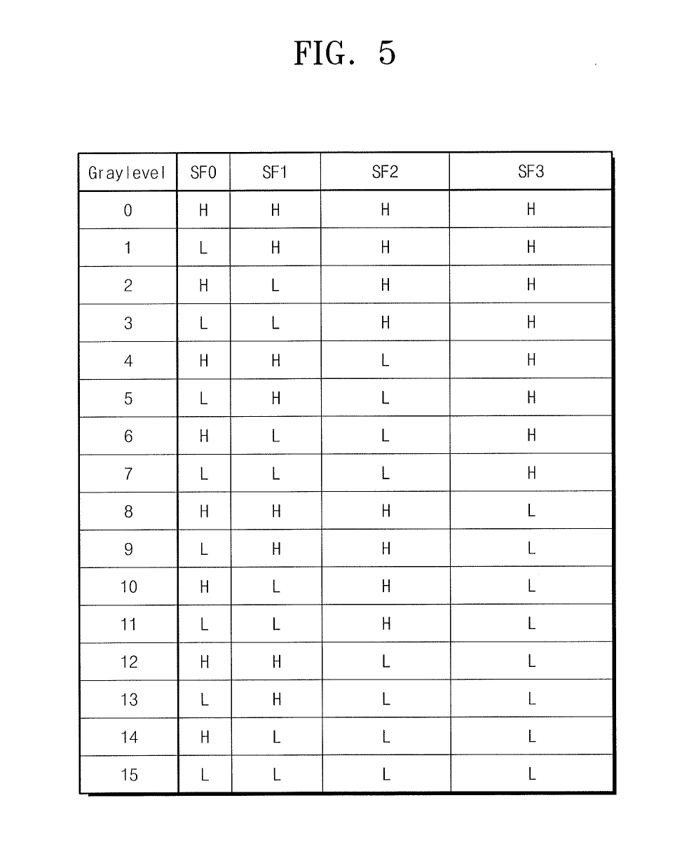

FIGS. 4 and 5 illustrates an embodiment of a method for driving a display apparatus. In the example of FIG. 4, the display apparatus 100 has 240 scan lines, the number of sub frames Nsf is 4 SF, the number of gray level bits is 4 bit, and the number of gray levels Ndv is 15 levels. Also, the 4 SF sub frames are referred to as SF0, SF1, SF2, and SF3, respectively. Also, the display apparatus 100 displays gray levels of light with four bits Nb and the number of gray levels Ndv is 15 levels according to a combination of sub frames enabling a pixel circuit to have a turn-on state among the sub frames SF0 to SF3.

In the example of FIG. 5, a combination of sub frames enabling the pixel circuit to have a turn-on state among the sub frames SF0 to SF3 is illustrated in correspondence with each gray level. As shown in FIG. 4, SF0 corresponds to a least significant bit (LSB) and SF3 corresponds to a most significant bit (MSB).

Also, when the ideal temporal weightings of the sub frames SF0 to SF3 are represented by WI₀ to WI₃, the ideal temporal weighting of each sub frame according to the present embodiment may be set, for example, based on Equation 2. In this example, “k” in Equation 2 is an integer and 0≦k≦3.

WIₖ=2^{k} (2)

Also, the integer k in the present embodiment may be used, for example, as a numerical value representing the arrangement of sub frames and a kth sub frame is referred to as SFk. In Equation 2, the ideal weighting WIₖ of each sub frame is as follows: WI₀=1, WI₁=2, WI₂=4, WI₃=8.

By weighting each of the sub frames SF0 to SF3 based on Equation 2, it is possible to displays gray levels of light in which the number of gray level bits Nb is 4 bit and the number of gray levels Ndv is 15 levels according to a combinations of sub frames enabling a pixel circuit to have a turn-on state.

For example, when only the sub frame SF0 is set to the L level, a pixel circuit is controlled to be switched on only for the period of a corresponding frame SF0, e.g., a period corresponding to the weighting WI₀=1, in a switch on period. Also, when only the sub frame SF1 is set to the L level, the pixel circuit is controlled to be switched on only for the period of a corresponding frame SF1, i.e., a period corresponding to the weighting WI₁=2, in a switch on period. Also, when the sub frames SF0 and SF1 are set to the L level, the pixel circuit is controlled to be switched on only for the periods of sub frames SF0 and SF1, i.e., a period corresponding to weighting WI₀+weighting WI₁=3, in a switch on period.

Due to the above-described configuration, the display apparatus 100 according to the present embodiment displays gray levels in which the number of gray levels Ndv is 15 levels according to a combination of sub frames set to the L level (e.g., enabling the pixel circuit to have an ON state) among the sub frames SF0 to SF3.

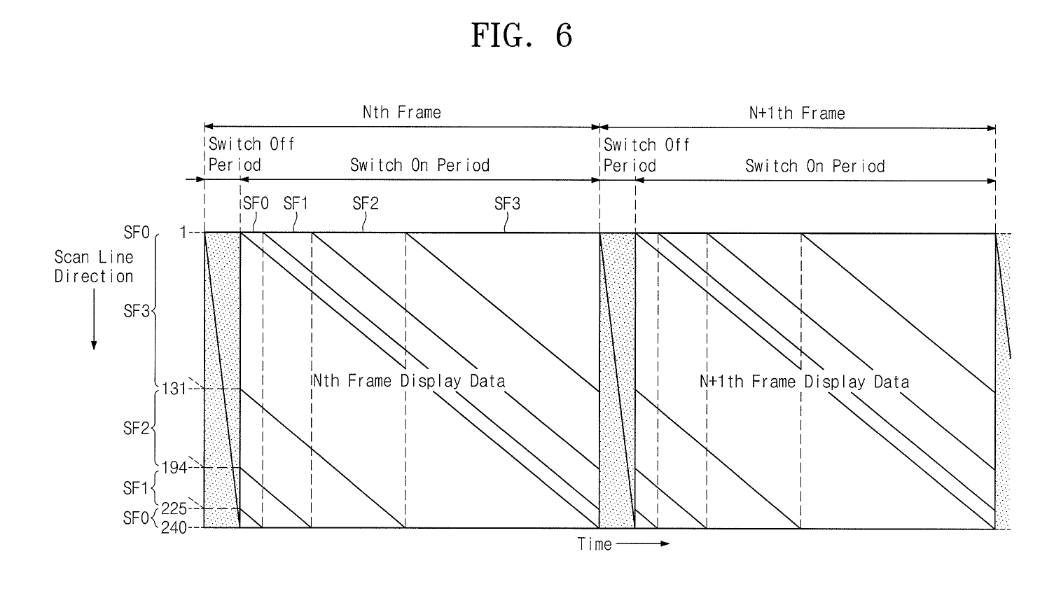

FIG. 6 illustrates an embodiment for selecting a scan line in accordance with the driving method. In FIG. 6, one frame includes a switch off period and a switch on period set after the switch off period. The switch on period is divided into the sub frames SF0 to SF3, and the display apparatus 100 displays light of a desired gray level by controlling a ratio of a period in which a pixel circuit is in a turn-on state, to the switch on period, according to a combination of sub frames enabling the pixel circuit to have the turn-on state. Also, the switch on period corresponds to an example of a display period.

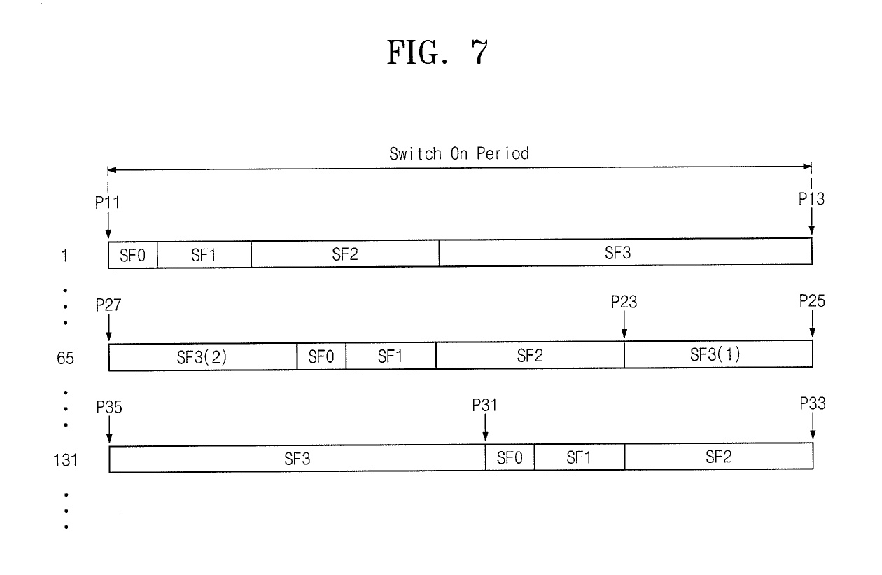

In this case, scanning timing for the first row scan line 112 is set according to the temporal weighting of a sub frame and a setting of corresponding scanning timing applied to each of other scan lines 112 through a sequential shift in time series in the switch time period. The setting of the scanning timing for each scan line 112 is described, for example, with reference to FIG. 7.

The example in FIG. 7 corresponds to first, 65-th, and 131-th row scan lines 112 and schematically represents scanning timing set for each scan line 112. For example, for the first row scan line 112, the sub frames SF0 to SF3 are sequentially allocated to a corresponding switch on period, in which case a time point represented by reference numeral P11 in the switch on period (e.g., a time point at which the switch on period is initiated) is a reference point. In this case, the initiation timing of the sub frame SF0, e.g., scanning timing for the sub frame SF0 is the timing point represented by reference numeral P11.

The initiation timing of the sub frame SF0 of the 131st row scan line 112 shifts in time series in the switch on period with respect to the scan line 112 corresponding to the first row, and is set as a time point represented by reference numeral P31. In this case, for the 131st row scan line 112, the sub frames SF0 to SF2 are allocated until a time point P33 at which the switch on period ends, by using a time point P31 as a reference point. The sub frame SF3 is allocated right before the reference point (e.g., time point P31) in the same switch on period.

Also, an example of setting scanning timing for the 65-th row scan line 112 shows that a time point at which the switch on period ends is located at a partial sub frame when the sub frames SF0 to SF3 are allocated to the switch on period based on a reference point. For example, an example of setting the 65-th row scan line 112 in FIG. 7 represents that a time point at which the switch on period ends represented by reference numeral P25 is located in the sub frame SF3. In this case, a period (sub frame SF3(1)) located before the time point P25 in the sub frame SF3 is allocated between the end time point P23 of the sub frame SF2 and the time point P25 at which the switch on period ends. Also, a period (sub frame SF3(2)) located after the time point P25 in the sub frame SF3 is allocated right before the reference point P21.

As such, in the display apparatus 100 according to the present embodiment, any time point in the switch on period is set as a reference point and a series of sub frames (i.e., sub frames SF0 to SF3) are cyclically allocated to each of the scan lines 112 in a priority-determined order using a corresponding reference point as a starting point. In this case, the reference point corresponding to each scan line 112 is set to be different time points between scan lines 112 through a sequential shift in time series in the switch on period, for example.

Due to such a configuration, the scanning timing of each scan line 112 is set to be the initiation timing of each of the sub frames SF0 to SF3 allocated in the switch on period according to a corresponding scan line 112.

Also, in the display apparatus according to the present embodiment, whether the display apparatus operates according to which of the sub frames SF0 to SF3 when the switch on period is initiated depends on the scan line 112, as may be seen for FIGS. 6 and 7. Therefore, the display apparatus 100 according to the present embodiment may supply a data signal to the pixel circuit connected to each scan line 112 depending on a corresponding sub frame before the initiation of the switch on period, and may supply a corresponding data signal for a switch off period. Also, the switch off period corresponds to an example of a preliminary period.

Referring back to FIG. 6, the embodiment for selecting a scan line based on the driving method is described in greater detail. Also, a method of setting scanning timing for each of the scan lines 112 is also described in detail.

Also, the term “Unit” according to the present embodiment may be defined as a “horizontal period of a number of successive sub frames Nsf to which the data signals of a number of sub frames Nsf (data signals of sub frames SF0 to SF3) are supplied in a switch on period.” In this case, the number of Units Nu in the switch on period is set, for example, based on Equation 3.

Nu=m (3)

In Equation 3, one frame is divided into m equivalent periods, each of which corresponds to one Unit. In this example, since the number of scan lines m is 240 as shown in FIG. 4, the number of Units Nu in the switch on period is 240 Unit. Also, in this example, calculating the number of Units Nu per frame means setting a weighting of each sub frame in unit of Unit, as described above. In other words, the minimum weighting of the sub frame is one Unit.

Next, the number of horizontal periods of the one frame is set. The number of horizontal periods in a switch off period Ndx₁ is set, for example, based on Equation 4.

Ndx₁=m (4)

In the present embodiment, since the number of scan lines m is 240 lines as shown in FIG. 4, the number of horizontal periods in the switch off period NDX₁ is 240 H. The number of horizontal periods in a switch on period Ndx₂ is set, for example, based on Equation 5.

Ndx₂=Nu×Nsf (5)

In the present embodiment, since as shown in FIG. 4, the number of scan lines m is 240 lines and the number of sub frames Nsf is 4 SF, the number of horizontal periods in the switch on period NDX₂ is 960 H.

When the number of horizontal periods in the switch on period NDX2 is allocated to a weighting of each sub frame based on the ideal weighting WIₖ of each sub frame, an actual pulse width PHₖ based on the horizontal period of each sub frame may be as follows: PH₀=65 H, PH₁=125 H, PH₂=253 H, and PH₃=509 H.

When the scanning timing of the first row scan line 112 in a switch on period is determined to approximately match with the weighting of each sub frame based on the actual pulse width PHₖ based on the horizontal period of a switch on period of each sub frame, the scanning timing SSₖ of the first row scan line 112 in the switch on period may be as follows: SS₀=0 H, SS₁=65 H, SS₂=190 H, and SS₃=443 H.

A SLₖ selected according to each sub frame in each Unit is set based on the scanning timing SSₖ of the first row scan line 112 in the switch on period. More particularly, a conditional expression represented by Equation 6 below is first defined by using a Unit number Un satisfying 0≦Un≦239.

$$Un - \frac{{SS}_{k} - k}{Nsf} \geq 0 \qquad ( 6 )$$

When the conditional expression represented by Equation 6 above is satisfied, the scan line SLₖ selected according to each sub frame in each Unit is set, for example, based on Equation 7.

$${SL}_{k} = Un - \frac{{SS}_{k} - k}{Nsf} + 1 \qquad ( 7 )$$

Also, when the conditional expression represented by Equation 6 above is not satisfied, the scan line SLₖ selected according to each sub frame in each Unit is set, for example, based on Equation 8.

$${SL}_{k} = Un - \frac{{SS}_{k} - k}{Nsf} + Nu + 1 \qquad ( 8 )$$

When the method of driving the display apparatus according to the first embodiment is used, the display apparatus 100 applies timing defined by the scanning timing SSₖ of the first row scan line 112 to all scan lines 112 through a sequential shift. Thus, the display apparatus 100 performs an operation of selecting e.g., 240 scan lines at certain timing. When a scan line to be selected is a scan line corresponding to a row equal to or larger than the 240th row, Equations 6 to 8 correspond to conditional expressions for resetting a scan line corresponding to a selected row, and the display apparatus 100 determines a scan line selection row in each sub frame of each Unit according to Equations 6 to 8.

Also, when the method of driving the display apparatus according to the present embodiment is used, one horizontal period 1H is set, for example, based on Equation 9.

$$1 H = \frac{1}{F \times ( {Ndx}_{1} + {Ndx}_{2} )} = \frac{1}{F \times m \times ( Nsf + 1 )} \qquad ( 9 )$$

In the present embodiment, since as shown in FIG. 4, the number of scan lines m is 240 lines and the number of sub frames Nsf is 4 SF, one horizontal period 1H is 13.9 μsec when the frame frequency F is 60 Hz.

The one horizontal period 1H according to Equation 9 has the same time as one horizontal period when the number of sub frames is Nsf+1 SF, for example, in the method according to the comparative example in FIG. 3. For example, for high precision, the number of scan lines m may be increased, the multi-gray levels corresponding to the number of sub frames Nsf may be increased, and the time period of the one horizontal period set may be less than the one horizontal period set by the method according to the comparative example in FIG. 3.

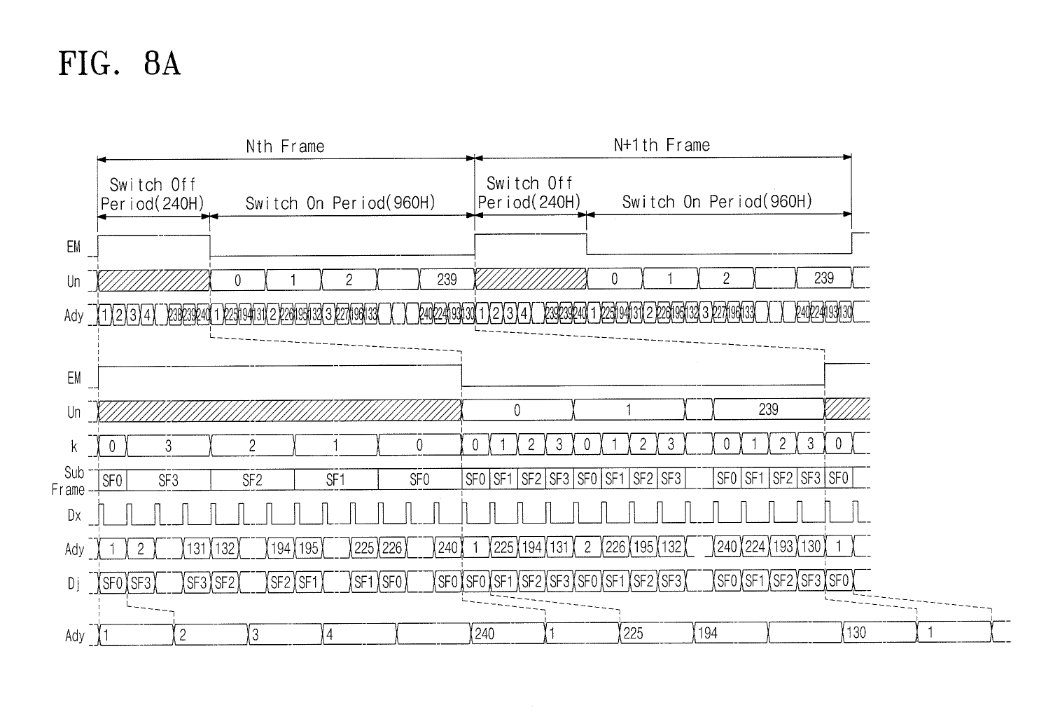

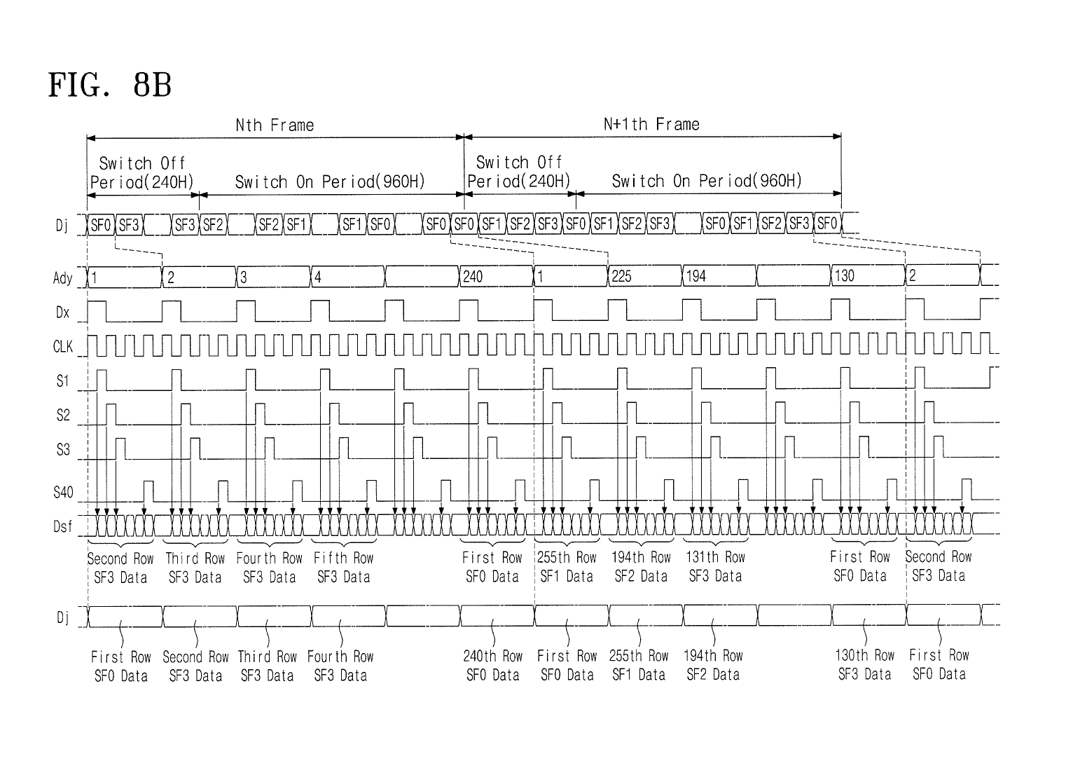

FIGS. 8A and 8B illustrate embodiments of the driving timing of the display apparatus 100 in a switch on period. In this example, FIGS. 8A and 8B represent an examples of driving timing when the display apparatus 100 includes 320 data lines 114 and 240 scan lines 112. As represented in FIG. 6, the sample/hold circuit 134 selects the data line 114 sequentially every block formed by eight data lines 114 based on sampling signals S1 to S40 transmitted from the shift register circuit 132.

The operation of the pixel circuit 110 in this case is described with reference to the pixel circuit 110. The display apparatus 100 sets the control signal EM to the L level in a switch on period to switch the third switch element M3 of a series of pixel circuits 100 to a turn-on state. Accordingly, the first switch element M1 is selectively turned on according to the signal level of the data bit Dj maintained at the capacitor C1 of each pixel circuit 110 and the light emitting element EL of a corresponding pixel circuit 110 has a light emitting state.

In addition, the display apparatus 100 repeats incrementing the arrangement order k of sub frames from 0 to 3 in synchronization with the horizontal synchronous signal Dx and resetting it to zero in synchronization with the horizontal synchronous signal Dx when k=3. Also, the display apparatus 100 resets a Unit number Un to 0 to be synchronized with a vertical synchronization signal Dy and increments the Unit number Un from 0 to 239 in synchronization with timing at which the arrangement order k of the sub frame is reset to 0.

The display apparatus 100 sets 4 H ranging from k=0 to k=3 as the one Unit by the above-described operation, for example.

Also, the display apparatus 100 may determine the scan line 112 to be selected based on a result of setting the driving timing according to the above-described first embodiment. For example, in one horizontal period in which the Unit number Un is 0 and the arrangement order of the sub frames k is 0, the address Ady becomes 1 by the data bit write of the sub frame SF0 and the display apparatus 100 selects the first row scan line 112. Therefore, in the above example, the scan line driving circuit 120 of the display apparatus 100 outputs an L-level scan signal G1 to the first-row scan line 112.

In one horizontal period in which the arrangement order of the sub frames k is 1, the address Ady becomes 225 by the data bit write of the sub frame SF1 and in this case, the display apparatus 100 selects the 225-th-row scan line 112.

Likewise, in one horizontal period in which the Unit number Un is 1 and the arrangement order of the sub frames k is 0, the address Ady becomes 2 by the data bit write of the sub frame SF0 and in this case, the display apparatus 100 selects the second-row scan line 112. Thus, in the above example, the scan line driving circuit 120 of the display apparatus 100 outputs an L-level scan signal G2 to the second-row scan line 112.

By repeating the above operations, the display apparatus 100 may apply the scan timing SSₖ of the first-row scan line 112 to all scan lines through a sequential shift, as in the scan line selection of each sub frame in a switch on period in FIG. 6.

An example of the driving timing of the display apparatus 100 based on the present embodiment in a switch off period is described with reference to FIGS. 8A and 8B. In the switch off period before a switch on period, the display apparatus 100 sets the control signal EM to the H level to switch the third switch element M3 (see FIG. 2) of the pixel circuit 100 to a turn-off state. Accordingly, irrespective of the signal level of the data bit Dj maintained at the capacitor C1 of each pixel circuit 110, the light emitting element EL of a corresponding pixel circuit 110 has a non-emission state.

When the light emitting element EL of the corresponding pixel circuit 110 is in the non-emission state, the display apparatus 100 increments the address Ady from 1 to 240 in synchronization with the horizontal synchronous signal Dx and sequentially selects all scan lines. According to a selected scan line, the display apparatus 100 outputs the data bit Dj at the initiation of the switch on period of each pixel circuit on the selected scan line (e.g., data bit Dj set to a sub frame at the initiation of the switch on period) to the data line 114.

In this example, a particular example is described with reference to FIGS. 6 and 8. The sub frame SF0 is located at the first-row scan line 112 at the initiation timing of the switch on period. Therefore, in a horizontal period in which the first-row scan line 112 is selected, the display apparatus 100 outputs the data bit of the sub frame SF0 to the data line 114.

Next, pay attention to the second to 131st row scan lines 112. The sub frame SF3 is located at the second to 131st row scan lines 112 at the initiation timing of the switch on period. Therefore, in a continuous horizontal period in which the second to 131st row scan lines 112 are selected, the display apparatus 100 outputs the data bit of the sub frame SF3 to the data line 114.

Likewise, in a continuous horizontal period in which the 132nd to 194th row scan lines 112 are selected, the display apparatus 100 outputs the data bit of the sub frame SF2 to the data line 114. Also, in a continuous horizontal period in which the 195th to 225th row scan lines 112 are selected, the display apparatus 100 outputs the data bit of the sub frame SF1 to the data line 114. Also, in a continuous horizontal period in which the 226th to 240th row scan lines 112 are selected, the display apparatus 100 outputs the data bit of the sub frame SF0 to the data line 114.

By the above-described operation, the display apparatus 100 previously writes, during a switch off period, a data bit at the initiation timing of the switch on period set right after a corresponding switch off period into all pixel circuits 110 configuring the display unit 102. In addition, after the completion of writing the data into each pixel circuit 110 during the switch off period, the display apparatus 100 sequentially selects each scan line 112 based on the operations during the above-described switch on period to driving the pixel circuit 110 connected to a corresponding scan line 112.

Due to such a configuration, only an image corresponding to an N-th frame period is displayed on the display apparatus 100 according to the present embodiment in the N-th frame period. Therefore, the display apparatus 100 according to the present embodiment may perform control according to an image display every frame. As a particular example, there may be peak brightness control that adjusts the brightness of the entire screen according to a light emitting area on the screen. When the peak brightness is performed, the display apparatus 100 may adjust the light emitting supply voltage ELVDD or the light emitting supply voltage ELVSS every frame, for example. Also, the light emitting area may be proportional to the number of pixels emitting light.

Due to the above-described configuration, the display apparatus 100 according to the present embodiment may restrict a period in which all pixel circuits are switched off, only to the switch off period represented in FIG. 6, e.g., a period in which each of all scan lines 112 are scanned exclusively once. Thus, the display apparatus 100 may display only an image corresponding to a corresponding frame during the one frame and maximize a switch on period for sub frame driving.

Also, the display apparatus 100 according to the present embodiment has a switch off period (e.g., a period in which black is displayed) between switch on periods in which an image corresponding to each frame is displayed, as described previously. Therefore, it is possible to achieve a secondary effect of reducing false contour, e.g., an afterimage when a moving object is displayed. Also, the switch off period is set longer than a period in which each of all scan lines 112 is scanned exclusively once, it is possible to appropriately adjust the switch off period.

A method of driving the display apparatus according to a second embodiment will now be described. In this embodiment, the display apparatus according to the first embodiment is applied to a so-called shutter-type 3D display apparatus. In such an apparatus, for example, an Nth frame period is an image display period for a left eye and an N+1th frame period is an image display period for a right eye.

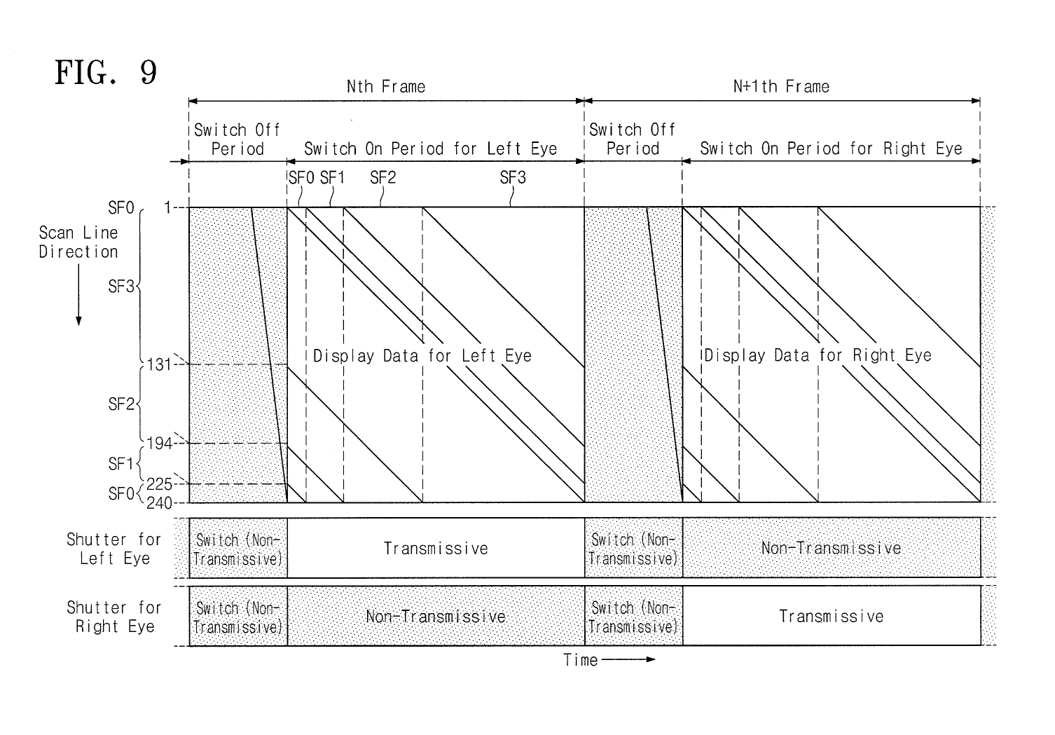

FIG. 9 illustrates an embodiment for selecting a scan line for the shutter-type 3D display apparatus. This embodiment selects a scan line when an N-th frame period is an image display period for a left eye, an (N+1)-th frame period is an image display period for a right eye, and a binocular shutter is switched between the display periods to display a 3D expression. Also, an example in the present embodiment describes that the frame frequency F is 120 Hz for the 3D expression.

The display apparatus 100 synchronizes a switch off period with a switch period of the binocular shutter in the present embodiment. For example, when the response speed of the binocular shutter is about 2 ms, the switch off period is also set to be about 2 ms. When the one horizontal period 1H is calculated based on a setting in FIG. 4, the frame frequency F is 120 Hz because the number of scan lines m is 240 Line and the number of sub frames Nsf is 4 SF. Therefore, when the frame frequency F is 120 Hz based on the calculation in Equation 9 as described previously, the one horizontal period 1 H is 6.9 μsec.

Also, it may be desired to sequentially select all 240 scan lines during the switch off period. However, since the time required to select all of the scan lines is about 1.66 ms smaller than the one horizontal period 1 H as described above, it is possible to select all the scan lines during the switch off period.

As described above, by writing a data bit into all pixel circuits 110 configuring the display unit 102 during the switch period of a shutter, it is possible to apply the display apparatus according to the first embodiment to the shutter-type 3D display apparatus. Also, the display apparatus 100 according to the present embodiment displays, in an Nth frame period, only an image corresponding to the Nth frame period, like the display apparatus according to the first embodiment as described above. Therefore, the display apparatus 100 according to the present embodiment may prevent an image for a right eye and an image for a left eye from becoming mixed in the one frame, and may provide a 3D expression having a clear image to a viewer without crosstalk.

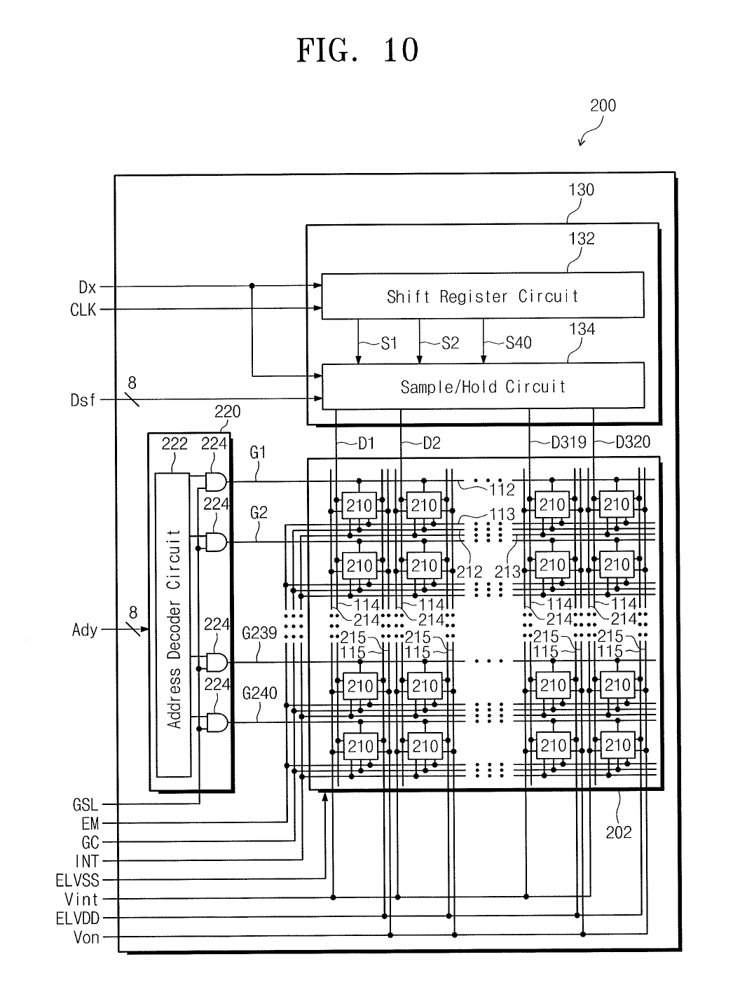

FIG. 10 illustrates a third embodiment of a display apparatus 200 which includes a display unit 202, a scan line driving circuit 220, and a data line driving circuit 130. The display unit 202 includes a plurality of pixel circuits 210 and displays an image corresponding to a data signal on a display screen. The pixel circuits 210 at respective intersections of a plurality of scan lines 112 and a plurality of data lines 114, that are orthogonal to the scan lines. The direction in which the scan lines 112 extend may be, for example, a row direction (Y direction), and the direction in which the data lines 114 extend may be in a column direction (X direction). The pixel circuits 210 may therefore be in a matrix shape. Also, in FIG. 10, 240 scan lines 112 are arranged in the row direction (Y direction) and 320 data lines 114 are arranged in the column direction (X direction). A different number of scan lines and/or data lines may be included in another embodiment.

A light emitting supply voltage ELVDD and a light emitting supply voltage ELVSS are supplied from a control or source circuit to the display unit 202. The light emitting supply voltage ELVDD and the light emitting supply voltage ELVSS are signals for supplying current for enabling a light emitting element possessed by the pixel circuit 210 to emit light.

Also, an initialization voltage Vint is supplied from a control or source circuit to the display unit 202. The initialization voltage Vint is a voltage signal for turning on the driving transistor DT of the pixel circuit 210 to be described. Also, it is described that the display apparatus 200 according to the present embodiment implement displays different gray levels based on the sub frame driving scheme like the display apparatus 100 according to the first embodiment.

The scan line driving circuit 220 includes an address decoder circuit 222 and an AND circuit 224. The AND circuit 224 is between the output terminal the address decoder circuit 222 and the scan line 112. In this case, one terminal of the AND circuit 224 is connected to the output terminal of the address decoder circuit 222, the other terminal thereof is connected to a global selection signal GSL supplied from a control or source circuit, and the output terminal is connected to the scan line 112.

When the global selection signal GSL becomes the H level, the scan line driving circuit 220 transmits the output state of each output terminal of the address decoder circuit 222 to the scan line 112 corresponding to the AND circuit 224. In this case, the scan line driving circuit 220 exclusively outputs an L-level scan line to the scan line 112 of a row designated by an address signal Ady supplied from a control or source circuit. Also, when the general selection signal GSL becomes the L level, the output of the AND circuit 224 becomes the L level irrespective of the output state of each output terminal of the address decoder circuit 222 and the L-level scan signal is output to all scan lines 112.

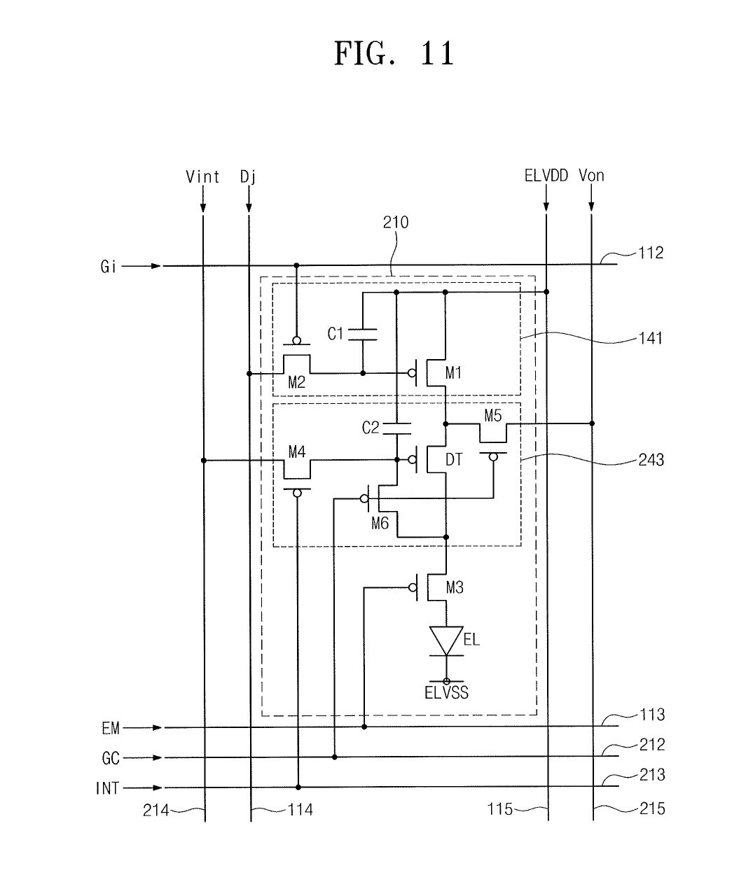

FIG. 11 illustrates an embodiment of the pixel circuit 210 at the intersection of an ith row and a jth column. The other pixel circuits 210 in the display unit 202 may have a similar configuration.

The pixel circuit 210 includes a light emitting element EL, a switch circuit 141, a constant current circuit 243, and a third switch element M3. The switch circuit 141 has may have the same configuration as the switch circuit 141 of the pixel circuit in the first embodiment of the display apparatus, which includes the first switch element M1, the second switch element M2, and the capacitor C1. For example, the switch circuit 141 turns on or off the first switch element M1 to control supplying a current to the constant current circuit 243 based on the light emitting supply voltage ELVDD.

The constant current circuit 243 includes a driving transistor DT, a fourth switch element M4, a fifth switch element M5, and a capacitor C2. The source terminal of a fourth switch element M4 is connected to a initialization voltage line 214, the drain terminal of a fourth switch element M4 is connected to the gate terminal of the driving transistor DT, and the fourth switch element M4 is turned-on or turned-off according to an initialization control signal INT transmitted to the gate terminal through an initialization signal line 213.

The source terminal of a fifth switch element M5 is connected to a constant current setting data voltage signal line 215, the drain terminal of a fifth switch element M5 is connected to the source terminal of the driving transistor DT, and the fifth switch element M5 is turned-on or turned-off according to a control signal GC transmitted to the gate terminal through a control signal line 212.

Terminals of a sixth switch element M6 are respectively connected to the gate and drain terminals of the driving transistor DT, and the sixth switch element M6 is turned-on or turned-off according to the control signal GC transmitted to the gate terminal through the control signal line 212.

One terminal of the capacitor C2 is connected to the gate terminal of the driving transistor DT, the other terminal thereof is connected to the light emitting supply voltage signal line 115, and the capacitor C2 maintains the potential of the gate terminal of the driving transistor DT.

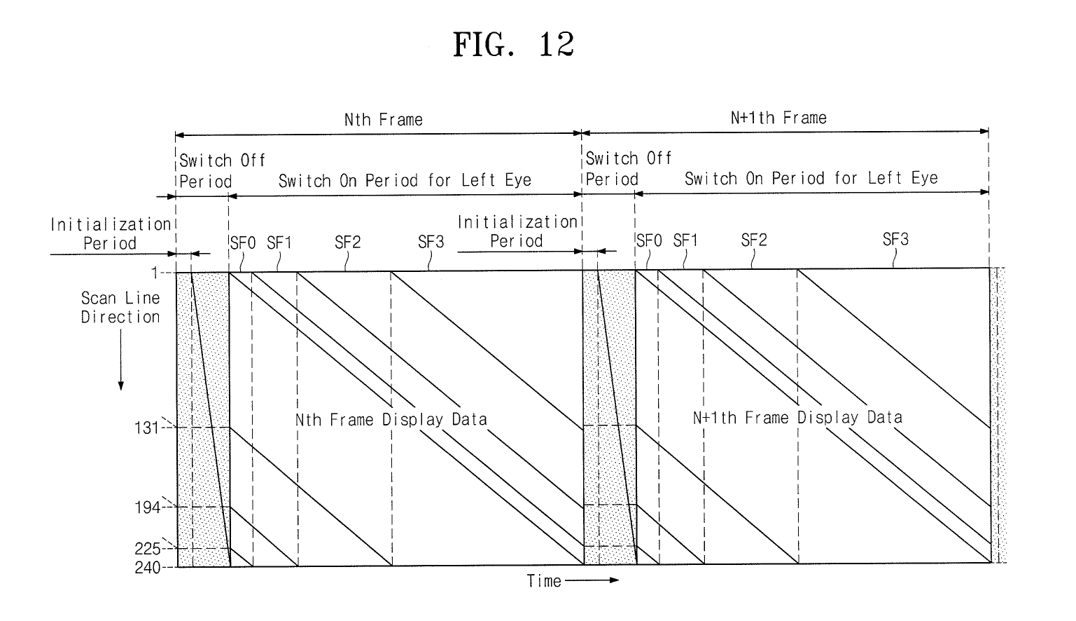

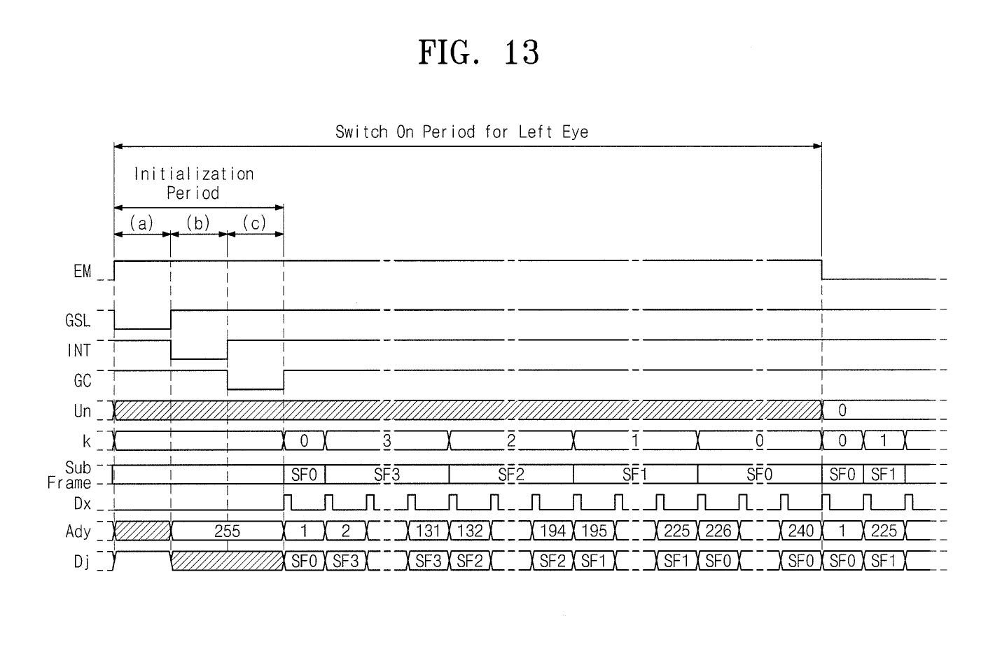

FIGS. 12 and 13 illustrate an embodiment of a method for driving this display apparatus 200. Referring to the FIG. 12, the display apparatus 200 is different from the display apparatus 100 in that during the switch off period, an initialization period is provided before a period in which a data bit is written into each pixel circuit 110.

In the switch off period before a switch on period, the display apparatus 200 sets the control signal EM to an H level to switch the third switch elements M3 of a series of the pixel circuits 210 to a turn-off state. Accordingly, irrespective of the signal level of the data bit Dj maintained at the capacitor C1 of each pixel circuit 210, the light emitting element EL of a corresponding pixel circuit 210 is in a non-emission state.

The initialization period is divided into three periods (a) to (c) as in FIG. 13.

In initialization period (a), the display apparatus 200 sets the general selection signal GSL to an L level, outputs an L-level scan signal to all scan lines 112, and switches the second switch elements M2 of all pixel circuits to a turn-on state. Accordingly, the H-level data bit Dj turning off the first switch element M1 is transmitted from the data line 114 to the gate terminal of the first switch element M1 through the second switch element M2, and the first switch element M1 is switched to a turn-off state.

In initialization period (b), the display apparatus 200 sets the general selection signal GSL to the H level, outputs an H-level scan signal to all scan lines 112, and switches the second switch elements M2 of all pixel circuits to a turn-off state. Accordingly, the H-level data bit Dj turning off the first switch element M1 is maintained at the capacitor C1.

Also, the display apparatus 200 sets the initialization control signal INT transmitted to the gate terminal through the initialization signal line 213 to the L level to switch the fourth switch elements M4 of all pixel circuits 210 to an ON state. Accordingly, the initialization voltage Vint turning on the driving transistor DT is transmitted from the initialization voltage signal line 214 to the gate terminal of the driving transistor DT through the fourth switch element M4, and the driving transistor is switched to a turn-on state.

In initialization period (c), the display apparatus 200 sets the initialization control signal INT to an H level to switch the fourth switch elements M4 of all pixel circuits 210 to a turn-off state. Accordingly, the initialization voltage Vint turning on the driving transistor DT is maintained at the capacitor C2.

Also, the display apparatus 200 sets the control signal GC transmitted to the gate terminal through the control signal line 212 to the L level to switch the fifth switch elements M5 and the sixth switch elements M6 of all pixel circuits 210 to a turn ON state. In this case, since the sixth switch element is turned on, the gate and drain terminals of the driving transistor DT are bypassed and the driving transistor DT becomes a state in which it is connected to a diode.

When the fifth switch element M5 and the sixth switch element M6 are turned on, a constant current setting voltage data voltage signal Von for setting the constant current circuit 243 to a predetermined constant current is transmitted from the constant current setting data voltage signal line 215 to the gate terminal of the driving transistor DT through the fifth switch element M5 and a diode-connected driving transistor DT.

In addition, when the gate terminal potential of the driving transistor DT reaches a potential obtained by subtracting the threshold voltage Vth of the driving transistor DT from the constant current setting voltage data voltage signal Von, the driving transistor DT is turned off. In this case, the constant current setting voltage data voltage signal Von obtained by compensating for the threshold voltage Vth of the driving transistor DT is maintained at the capacitor C2.

In such a configuration, the constant current circuit 243 outputs a constant current through the driving transistor DT according to the constant current setting voltage data voltage signal Von maintained at the capacitor C2. Also, when the constant current setting voltage data voltage signal Von enables the light emitting element to continue to emit light during a switch on period provided during the one frame for example, setting may be implemented such that current values which all white luminance may obtain are output by the constant current circuit 243.

When the initialization period (c) expires, the display apparatus 200 sets the control signal GC to an H level to switch the fifth switch elements M5 and the sixth switch elements M6 of all pixel circuits 210 to a turn-off state. The following operations are the same as those of the method of driving the display apparatus according to the first embodiment. For example, the display apparatus 200 increments the address Ady from 1 to 240 in synchronization with the horizontal synchronous signal Dx and sequentially selects all scan lines. In addition, the data bit Dj at the initiation of the switch on period of each pixel circuit on a selected scan line is output to the data line 114.

FIG. 13 illustrates an embodiment of a method for providing constant current for a pixel circuit. Referring to FIG. 13, the method includes controlling a corresponding constant current circuit during the initialization periods (e.g., (a) to (c)). With such a configuration and control, the driving transistor of a corresponding constant current circuit enables the threshold voltage Vth to drive based on a compensated voltage.

In such a configuration, the display apparatus according to the present embodiment supplies a constant current (e.g., a predetermined current) to the light emitting element of each pixel circuit, even if there is a change in the characteristics of the driving transistor, and especially for changes in the threshold values Vth among pixel circuits. Therefore, the display apparatus according to the present embodiment may decrease the influence of a change in the characteristics of the driving transistor on an image display, and display a clear image that has higher reproductivity.

Also, the display apparatus according to the present embodiment may display only an image corresponding to a corresponding frame during the one frame like the first embodiment as described above, and maximize a switch on period for sub frame driving. Also, the display apparatus according to the present embodiment may be the same as that of the first embodiment, in that it is also possible to reduce false contour, e.g., an afterimage when a moving object is displayed may. Also, when peak luminance control adjusting the luminance of the entire screen is controlled according to a light emitting area on the screen, the display apparatus 200 may, for example, adjust the constant current setting voltage data voltage signal Von every frame.

A display apparatus 300 according to a fourth embodiment compensates for changes in the voltage-current VI characteristics and IL characteristics of a light emitting element to decrease the influence (e.g., a decrease in picture quality) of luminance unevenness involved in the change on an image display. In particular, the display apparatus 300 measures the VI characteristics of the light emitting element and compensates for the VI characteristics and IL characteristics of the light emitting element based on a measurement result.

Also, the display apparatus 300 provides a detection period for detecting the VI characteristics of the light emitting element during a switch off period and controls the light emitting of the light emitting element according to an image display and the detection of the VI characteristics of the light emitting element every pixel circuit. When detection is performed on a targeted pixel circuit on which the detection of VI characteristics is performed (“targeted pixel circuit”), the display apparatus 300 corrects display data that is data corresponding to an image to be displayed on the display unit.

By correcting the display data as described above, the amount of light emission of the light emitting element of the targeted pixel circuit during the one frame corresponds to an amount of light emission based on the display data after correction. Also, since the display data is corrected, the amount of light emission of the targeted pixel circuit and an amount of light emission of a pixel circuit being not the target to detect the VI characteristics (“non-targeted pixel circuit”) in any one frame become the same, when in the one frame, the display data of the one frame corresponding to the targeted pixel circuit is the same as the display data of the one frame corresponding to the non-targeted pixel circuit.

Thus, since the display apparatus according to the present embodiment corrects the display data as described above for example, it is possible to match the display data with the amount of light emission in the one frame even when the VI characteristics are detected.

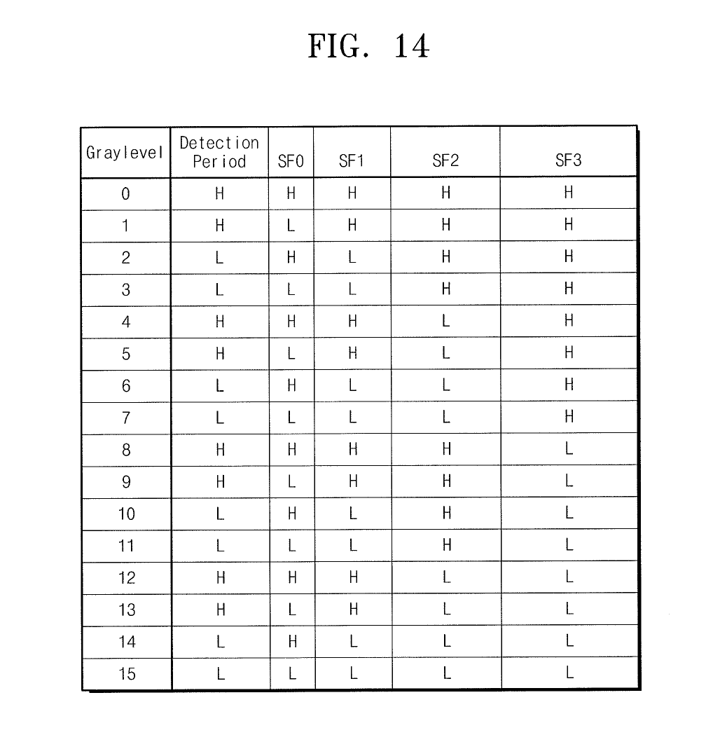

FIG. 14 illustrates an example of the operation overview of the display apparatus 300. The example in FIG. 14 includes display data and a light emitting state of a light emitting element in a pixel circuit according to the present embodiment. The display apparatus 300 provides a detection period in addition to sub frames SF0 to SF3. The detection period controls the light emission and non-emission of a pixel circuit, for example, as may be seen through a comparison with the example in FIG. 5. Also, the detection period is a period for measuring the VI characteristics of the light emitting element.

Referring to FIGS. 14 and 5, the display apparatus 300 sets, for a pixel circuit at which the sub frame SF1 is set to the L level in each gray level of the example in FIG. 5, the data bit of the detection period to an L level and a corresponding sub frame SF1 to an H level. Also, the sub frames SF0, SF2 and SF3 are the same as those in FIG. 5.

Also, although in the example in FIG. 14 the detection period is the sub frame SF1 period, a targeted sub frame is not necessarily limited to the sub frame SF1 when it is possible to obtain, as the detection period, a period equal to or longer than a time needed for detection.

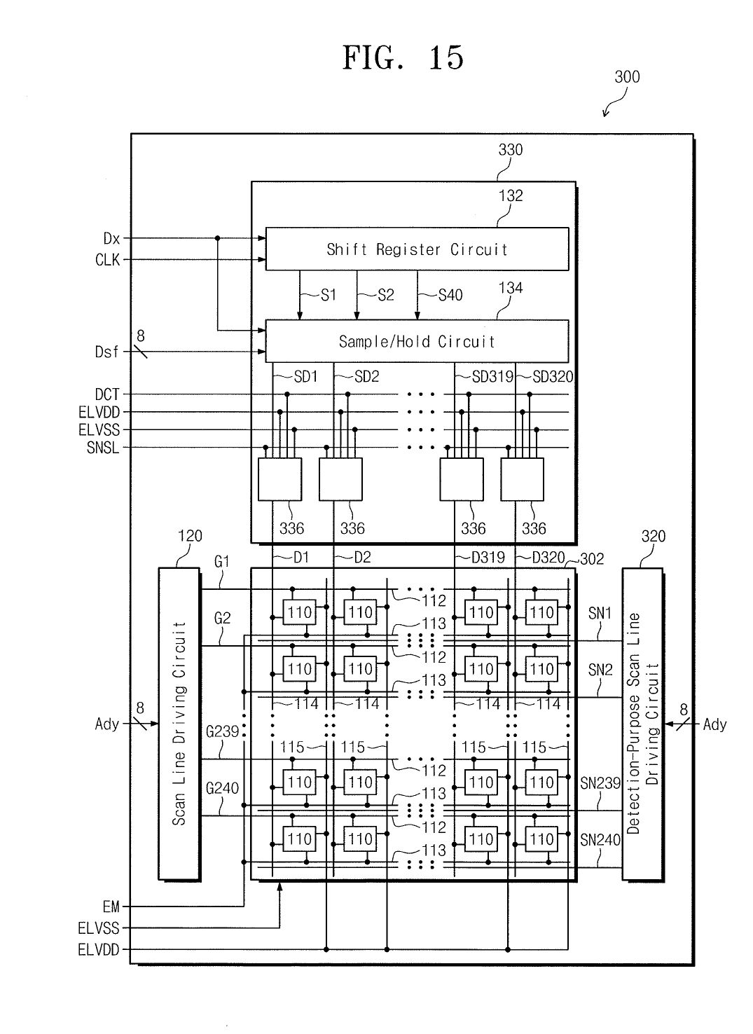

FIG. 15 illustrates an embodiment of the display apparatus 300 which includes a display unit 302, a scan line driving circuit 120, a data line driving circuit 330, and a detection-purpose scan line driving circuit 320.

The display unit 302 includes a plurality of pixel circuits 310 and displays an image corresponding to a data signal on a display screen. The pixel circuits 310 are at respective intersections of scan lines 112 and data lines 114 which may be orthogonal to each other. For example, the direction in which the scan lines 112 extends is a row direction (Y direction), and the direction in which the data lines 114 extends is a column direction (X direction). Thus, the pixel circuits 310 are in a matrix shape. Also, in FIG. 15, 240 scan lines 112 are arranged in the row direction (Y direction) and 320 data lines 114 are arranged in the column direction (X direction). A different number of scan lines and/or data lines may be included in another embodiment.

Also, a light emitting supply voltage ELVDD and a light emitting supply voltage ELVSS are supplied from a control or source circuit to the display unit 302. The light emitting supply voltage ELVDD and the light emitting supply voltage ELVSS are signals for supplying a current for enabling a light emitting element possessed by the pixel circuit 310 to emit light.

Also, the data line driving circuit 330 according to the present embodiment is different form the data line driving circuit 130 in that the data line driving circuit 330 includes a detection circuit 336. The detection circuit 336 detects the VI characteristics of the light emitting element by current detection when the data bit Dj is output to the data line 114.

The detection-purpose scan line driving circuit 320 includes a kind of an address decoder that exclusively outputs an L-level detection-purpose scan signal to the detection-purpose scan line 312 of a row designated by an address signal Ady supplied from a control or source circuit. Also, detection-purpose scan signals supplied to first, second, third, . . . and 240th row detection-purpose scan lines 312 are denoted by SN1, SN2, SN3, . . . , and SN240, respectively and one of the detection-purpose scan signals is represented by SNi (where i is an integer and 1≦I≦240).

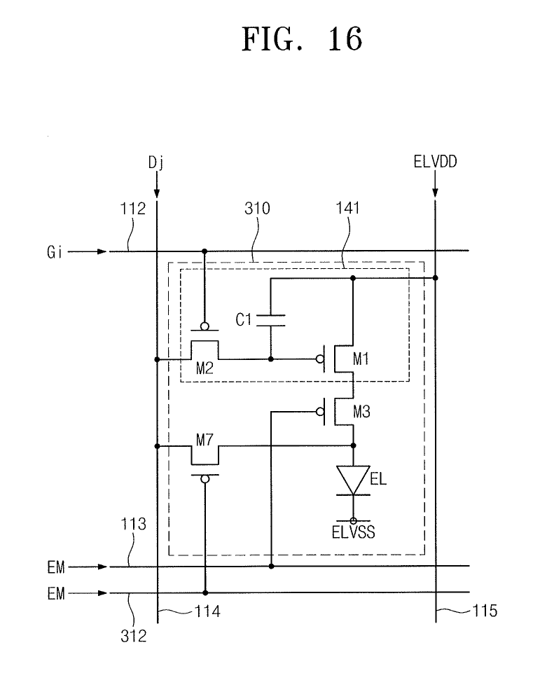

FIG. 16 illustrates an embodiment of the pixel circuit 310 at the intersection of an ith row and a jth column. The other pixel circuits 310 in the display unit 302 may have a similar configuration.

The pixel circuit 310 includes a light emitting element EL, a switch circuit 141, a third switch element M3, and a seventh switch element M7. The switch circuit 141 has the same configuration as the switch circuit 141 of the pixel circuit in the first embodiment of the display apparatus, which includes the first switch element M1, the second switch element M2, and the capacitor C1. For example, the switch circuit 141 turns on or off the first switch element M1 to control the supplying of a current to the third switch element M3 based on the light emitting supply voltage ELVDD.

The source terminal of the seventh switch element M7 is connected to the data line 114, the drain terminal thereof is connected to the drain terminal of the third switch element M3 and the anode terminal of the light emitting element EL, and the seventh switch element is turned-on or turned-off according to the detection-purpose scan signal SNi transmitted to the gate terminal through the detection-purpose scan line 312.

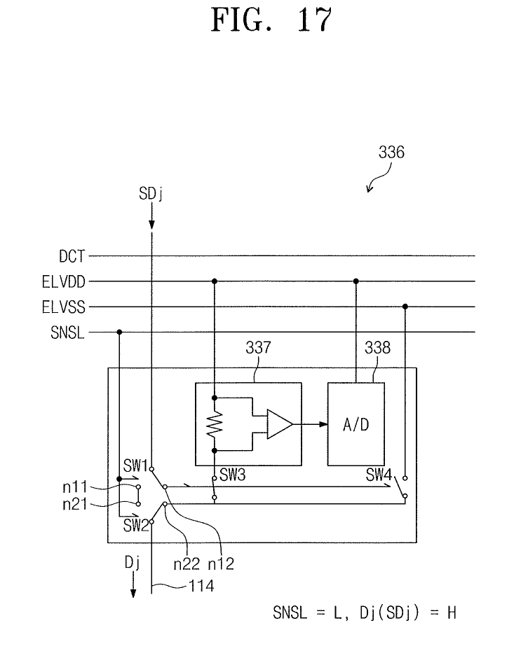

FIGS. 17 to 19 illustrate different states of operation of an embodiment of the detection circuit 336 which includes switches SW1 to SW4, a current measurement circuit 337, and an A/D conversion circuit 338. The switches SW1 and SW2 cooperatively operate based on a detection selection signal SNSL from a control circuit. The switches SW1 and SW2 may be any switch elements that may have an ON state or OFF state cooperatively based on the detection selection signal SNSL, such as MOSFETs having the same conductive type.

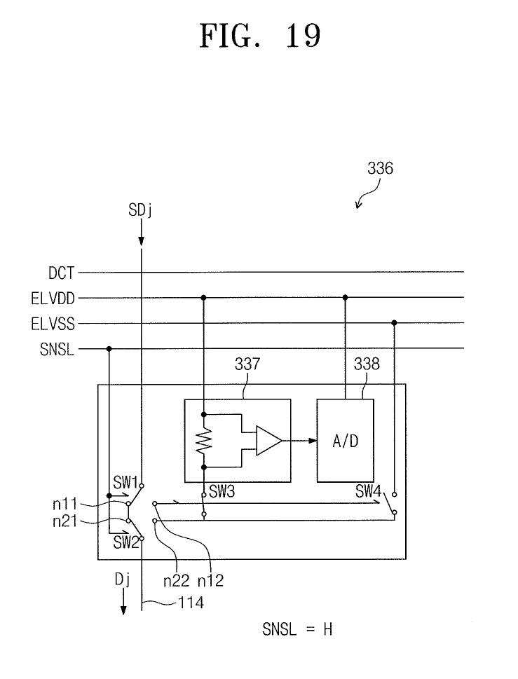

When an H-level signal is transmitted to the switches SW1 and SW2 as the detection selection signal SNSL, the switch SW1 is connected to a node n11 and the switch SW2 is connected to a node n21, as in FIG. 19. In this case, a data bit SDj output from the sample/hold circuit 134 is supplied to each pixel circuit 310 as a data bit Dj through the switches SW1 and SW2 and the data line 114.

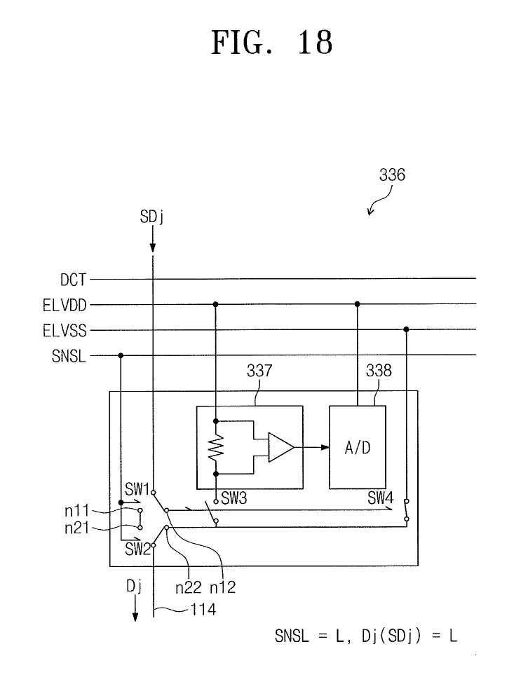

Also, when an L-level signal is transmitted to the switches SW1 and SW2 as the detection selection signal SNSL, the switch SW1 is connected to a node n12 and the switch SW2 is connected to a node n22, as in FIGS. 17 and 18. In this case, the data bit SDj output from the sample/hold circuit 134 is transmitted to the switches SW3 and SW4 through the switch SW1.

The current measurement circuit 337 measures a current flowing through the data line 114 when detecting the characteristics of the light emitting element EL of the pixel circuit 310. The A/D conversion circuit 338 converts a current value measured by the current measurement circuit 337 into a digital signal.

The switches SW3 and SW4 are configured to be exclusively turned on or off based on the data bit SDj transmitted through the switch SW1 from the sample/hold circuit 134. The switches SW3 and SW4 may include any switch elements that may be exclusively turned on or off based on a selection signal VSENSE_SEL, such as MOSFETs having different conductive types.

When an H-level signal is transmitted to the switches SW3 and SW4 as the data bit SDj, the switch S3 is turned on and the switch is turned off, as in FIG. 17. In this case, the light emitting supply voltage ELVDD is supplied from a control circuit to each pixel circuit 310 as the data bit Dj through the current measurement circuit 337, the switch SW3, the switch SW2, and the data line 114. In this case, the characteristics of the light emitting element EL of the pixel circuit 310 are detected.

In particular, the detection circuit 336 measures the current value of a current supplied to the light emitting element EL. The current value of the current measured by the detection circuit 336 is converted to a digital signal by the A/D conversion circuit 338, and transmitted to a control circuit as data (DCT) representing the VI characteristics of the light emitting element EL. In this case, the control circuit corrects data bit SDj transmitted to a corresponding pixel circuit 310 based on the data DCT representing the VI characteristics of the light emitting element EL. Accordingly, changes in the VI characteristics and IL characteristics of the light emitting element EL are compensated for and a reduction in luminance unevenness (e.g., picture quality) in a displayed image may be achieved.

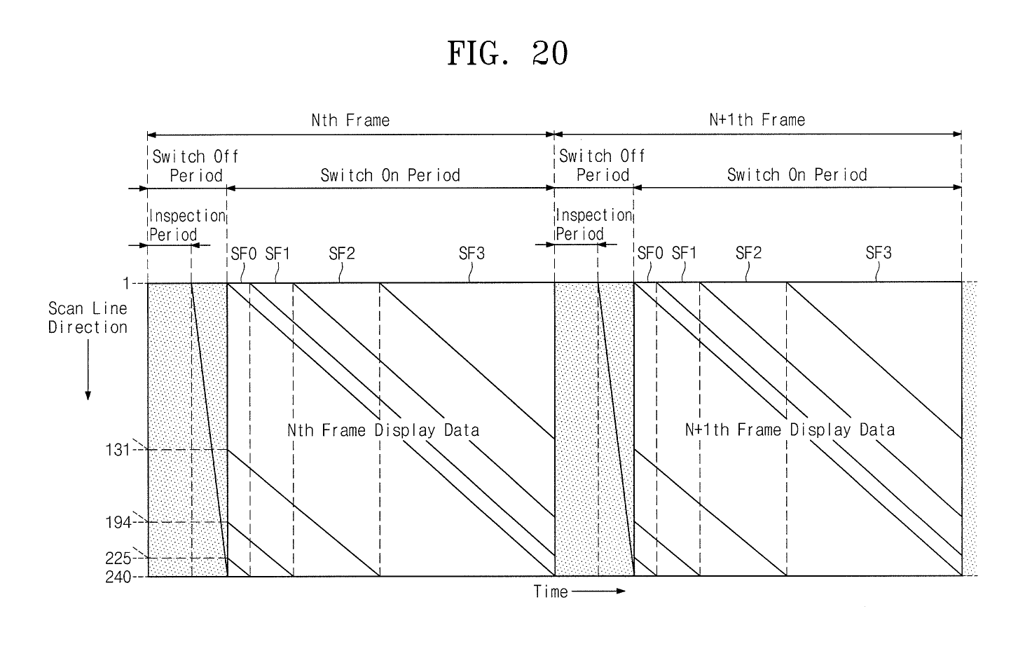

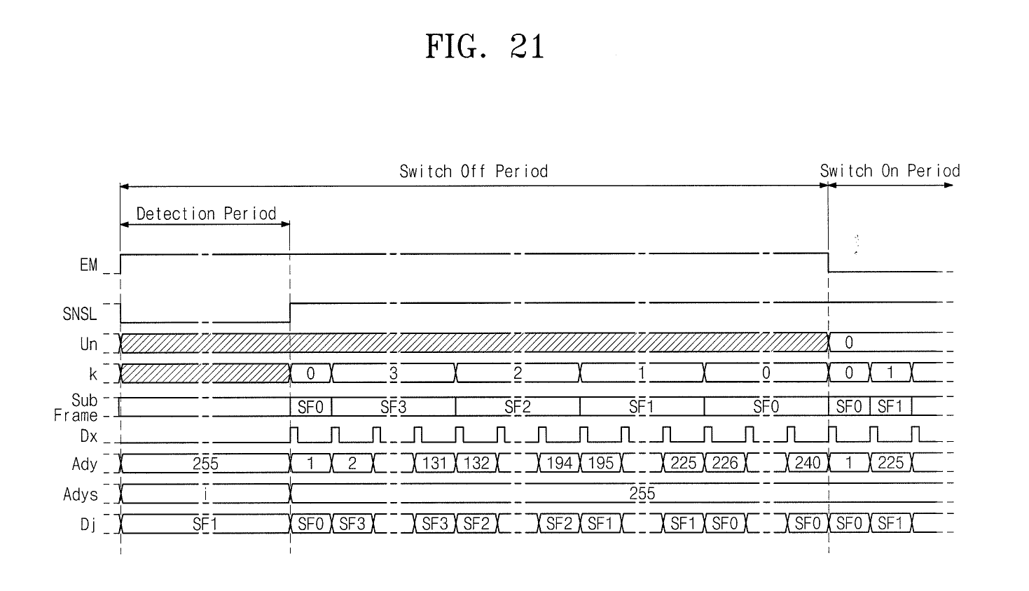

FIGS. 20 and 21 illustrate another embodiment of method for driving the display apparatus 300. FIG. 20 illustrates an embodiment for selecting a scan line, and FIG. 21 illustrates waveforms for explaining driving timing based on the driving method.

Referring to FIG. 20, the display apparatus 300 according to the present embodiment is different from the display apparatus 100 according to the first embodiment, in that during the switch off period, a detection period is provided before a period in which a data bit is written into each pixel circuit 110. The following descript of the driving method for display apparatus 300 focuses on the detection period for the pixel circuit 310 in FIG. 16 and the detection circuit 336 in FIGS. 17 to 19.

In the detection period during a switch off period, a control circuit may set the detection selection signal SNSL to an L level to enable the VI characteristics of the light emitting element to be detected by current detection.

Also, by outputting an address Ady corresponding to the detection-purpose scan line 312 to be detected, the control circuit may select the detection-purpose scan line 312, e.g., ith row detection-purpose scan line 312 and enables the switch element M7 of a selected pixel circuit 310 to have an ON state.

Also, by taking the address Ady equal to or greater than 241 (e.g., 255) and outputting H-level scan signals G1 to G240 to all scan lines 112, the control circuit may maintain the switch elements M2 of all pixel circuits 310 in an OFF state.

Also, data bits SD1 to SD240 of sub frame SF1 are output from the sample/hold circuit 134 to the detection circuit 336 at the same time in the switch on period of an ith row pixel circuit 310.

When an input data bit SDj is of an H level, the detection circuit 336 becomes a connection state as in FIG. 17 and the light emitting supply voltage ELVDD is supplied to the data line 114 as a data bit Dj through the current measurement circuit 337. Also, when the input data bit SDj is of an L level, the detection circuit 336 becomes a connection state as in FIG. 18 and the light emitting supply voltage ELVSS is supplied to the data line 114 as the data bit Dj.

The data bit Dj supplied to the ith row pixel circuit 310 is supplied to the light emitting element EL through the switch element M7 of a corresponding pixel circuit 310. In this case, when the data bit Dj is the light emitting supply voltage ELVDD, the light emitting element EL emits light and a current supplied to the light emitting element EL is detected from the current measurement circuit 337 of the detection circuit 336. The current detected by the current measurement circuit 337 is converted to a digital signal by the A/D conversion circuit 338, and transmitted to a control circuit as data (DCT) representing the VI characteristics of the light emitting element EL. In addition, the control circuit corrects data bit SDj transmitted to a corresponding pixel circuit 310, based on the data DCT representing the VI characteristics of light emitting element EL.

As described above, the display apparatus according to the present embodiment provides a detection period during a switch on period and detects, in the detection period, current flowing through the light emitting element of a targeted pixel circuit to detect the VI characteristics of the light emitting element. In addition, the display apparatus according to the present embodiment corrects the data bit SDj transmitted to a corresponding pixel circuit 310 based on the VI characteristics of the light emitting element detected to adjust an amount of light emission of the light emitting element. In such a configuration, the display apparatus according to the present embodiment may compensate for changes in the VI characteristic and IL characteristics of the light emitting element of each pixel circuit and decrease the influence (e.g., a decrease in picture quality) of luminance unevenness involved in the changes on an image display.

In accordance with one or more of the aforementioned embodiments, a display apparatus writes, during a switch off period, data bits at the initiation timing of a switch on period set right after a corresponding switch off period, into all pixel circuits configuring the display unit. In addition, after the completion of writing a data bit into each pixel circuit during the switch off period, a corresponding display apparatus sequentially selects each scan line in synchronization with the initiation timing of each sub frame assigned to a switch on period according to a scan line and drives a pixel circuit connected to the scan line.

In such a configuration, only an image corresponding to an Nth frame period is displayed on the display apparatus according to each embodiment in the Nth frame period. Therefore, the display apparatus may perform control according to an image display every frame.

In such a configuration as described above, the display apparatus may also restrict a period in which all pixel circuits are switched off, only to the periods as represented in FIGS. 6, 9 and 12. For example, the display apparatus 100 may display, during the one frame, only an image corresponding to a corresponding frame and maximize a switch on period for sub frame driving.

Also, the display apparatus may have a switch off period (e.g., a period in which black or other predetermined data is displayed) between switch on periods in which an image corresponding to each frame is displayed. Therefore, it is possible to reduce false contour, e.g., an afterimage when a moving object is displayed.

Also, a series of operations as described above may be configured by a program for operating the CPU of an apparatus operating each component of the display apparatus. The program may be configured to be executed by an operating system (OS) installed in the apparatus. Also, a location in which the program is stored is not limited as long as an apparatus including the configuration executing the above-described processing may read. For example, the program may also be stored in a recording medium connected from the outside of the apparatus. In this case, by connecting the recording medium storing the program to the apparatus, the CPU of the apparatus executes a corresponding program.

By way of summation and review, according to one proposed sub frame driving method, one frame is divided a plurality of sub frames and the light emitting element is switched in an ON state or OFF state during each sub frame. However, when this method is applied to a shutter-type 3D display apparatus, crosstalk occurs because the image for the right eye and the image for the left eye are mixed in one frame. In accordance with one or more of the aforementioned embodiments, a display is driven by a sub frame driving method using an interlaced scan scheme. Through this method, it is possible to reduce or minimize a switch-off period in which all pixel circuits are turned-off during the one frame, and to display only an image of a corresponding frame for each frame.

Example embodiments have been disclosed herein, and although specific terms are employed, they are used and are to be interpreted in a generic and descriptive sense only and not for purpose of limitation. In some instances, as would be apparent to one of skill in the art as of the filing of the present application, features, characteristics, and/or elements described in connection with a particular embodiment may be used singly or in combination with features, characteristics, and/or elements described in connection with other embodiments unless otherwise indicated. Accordingly, it will be understood by those of skill in the art that various changes in form and details may be made without departing from the spirit and scope of the present invention as set forth in the following claims.

What is claimed is:

1. A display apparatus, comprising:
a plurality of pixel circuits at respective intersections of a plurality of scan lines and a plurality data lines;
a scan line driving circuit to supply a scan signal to each of the scan lines to exclusively select the scan line; and
a data line driving circuit to supply a data signal to the data lines to turn-on or turn-off the pixel circuits connected to a selected scan line, wherein a display period for displaying an image of one frame is divided into a plurality of sub frames, wherein the pixel circuits are to be turned on or turned off every corresponding sub frame to display an image expressed by a plurality of gray levels on a screen, wherein, for each of the scan lines, the series of sub frames is assigned in the display period using a time point in the display period as a reference point, and wherein for each pixel circuit:
during a preliminary period preset for the one frame, the scan line driving circuit is to sequentially select a scan line of the pixel circuit and the data line driving circuit is to supply the data signal to the data line of the pixel circuit based on the reference point, and
during the display period of the one frame, the scan line driving circuit is to select scan line connected to the pixel circuit in synchronization with an initiation timing of each sub frame of the display period, and the data line driving circuit is to supply the data signal to the data line connected to the pixel circuit based on a state of the sub frame corresponding to initiation timing.

2. The display apparatus as claimed in claim 1, wherein:
for each of the scan lines, the series of sub frames is assigned cyclically in a priority-determined order with respect to the display period using the reference point as a starting point.

3. The display apparatus as claimed in claim 2, wherein:
a period occupied by each of the series of sub frames during the display period is to be priority-weighted, and
different gray levels are to be displayed with respect to respective combinations of the sub frames in which the pixel circuit has a turn-on state.

4. The display apparatus as claimed in claim 2, wherein the preliminary period is set to be longer than a period in which the scan line driving circuit is to exclusively select the scan lines.

5. The display apparatus as claimed in claim 4, wherein:
for each of the scan lines, the sub frames are to be assigned for the display period using different time points in the display period as the reference point.

6. The display apparatus as claimed in claim 5, wherein all of the pixel circuits are turned-off during the preliminary period.

7. The display apparatus as claimed in claim 6, wherein:
when the display apparatus is to time-divisionally display an image for a left eye and an image for a right eye every frame, the preliminary period is to be set within a switch period for switching the left-eye image and the right-eye image.

8. The display apparatus as claimed in claim 7, wherein luminance of the display screen in the one frame is to be adjusted according to a number of the pixel circuits turned on during the display period of the one frame.

9. The display apparatus as claimed in claim 8, wherein the luminance of the display screen in the one frame is to be adjusted according to a supply voltage supplied to the pixel circuit.

10. The display apparatus as claimed in claim 9, wherein the pixel circuit includes:
a light emitting element;
a capacitor to maintain a supplied data signal; and
a switch element to be switched to one of a conductive state or a non-conductive state based on the data signal maintained at the capacitor, wherein:
based on selection of the scan line by the scan line driving circuit, the supplied data signal is to be maintained at the capacitor of the pixel circuit connected to the scan line, and
based on non-selection of the scan line, the switch element is switched based on the data signal maintained at the capacitor and supply of current to the light emitting element is to be controlled.

11. The display apparatus as claimed in claim 8, wherein each pixel circuit includes:
a light emitting element;
a capacitor to maintain a supplied data signal;
a switch element switched to one of a conductive state or a non-conductive state based on the data signal maintained at the capacitor; and
a constant current circuit to enable a current value of the current supplied to the light emitting element to have a predetermined value, wherein:
based on selection of the scan line by the scan line driving circuit, the supplied data signal is to be maintained at the capacitor of the pixel circuit connected to a corresponding scan line, and
based on non-selection of the scan line, the switch element is to be switched based on the data signal maintained at the capacitor and supply of current to the light emitting element is to be directly or indirectly controlled.

12. The display apparatus as claimed in claim 11, wherein the constant current circuit is connected between the switch element and the light emitting element.

13. The display apparatus as claimed in claim 12, wherein the constant current circuit includes:
a driving transistor including a control terminal, a first terminal connected to a switch element side, and a second terminal connected to a light emitting element side;
a second capacitor connected to a control terminal side of the driving transistor; and
a second switch element between the control terminal and the second terminal and to switch between a conductive state and a non-conductive state, wherein:
when the second switch element is in the conductive state, the control terminal and the second terminal are bypassed, and a control signal supplied from the first terminal of the driving transistor to the control terminal thereof to drive a corresponding driving transistor is to be maintained at the second capacitor, and
supply of a current to the light emitting element through the driving transistor is to be directly or indirectly controlled based on the control signal maintained at the second capacitor.

14. The display apparatus as claimed in claim 13, wherein:
during the preliminary period, the second switch element is to be controlled to be in the conductive state in a period before the data line driving circuit is to supply the data signal to a corresponding one of the pixel circuits.

15. The display apparatus as claimed in claim 14, wherein luminance of the display screen in the one frame is to be adjusted according to the control signal maintained at the second capacitor.

16. The display apparatus as claimed in claim 8, wherein the pixel circuit includes:
a light emitting element,
the display apparatus includes a detector to detect current flowing in the corresponding light emitting element during the preliminary period, and
based on a detection result of the current every pixel circuit, an amount of light emission of a corresponding pixel circuit in the one frame is to be adjusted.

17. A method for driving a display apparatus, the method comprising:
sequentially selecting a plurality of scan lines; and
supplying data signals to the selected scan lines, which are connected to corresponding pixel circuits, each of the data signals supplied to a selected scan line based on a reference point, wherein:
in a display period, sequentially selecting the scan lines includes sequentially selecting the scan lines in synchronization with an initiation timing of each sub frame assigned with respect to the display period for each scan line; and
supplying data signals to respective ones of the pixel circuits connected to the selected scan lines, the data signals supplied based on the state set for each sub frame in synchronization with the initiation timing.

18. An apparatus, comprising:
a scan line driver to select each of a plurality of scan lines; and
a data line driver to supply data signals to data lines to turn-on or turn-off corresponding pixel circuits connected to the selected scan lines, wherein:
a display period of a frame includes a plurality of sub frames,
the pixel circuits are to be turned on or turned off every sub frame to display an image,
for each of the scan lines, the sub frames are assigned in the display period based on a reference point, and
for each pixel circuit:
(a) during a preliminary period of the frame, the scan line driver circuit is to select the scan line connected to the pixel circuit and the data line driving circuit is to supply the data signal to the data line connected to the pixel circuit based on the reference point,
(b) during the display period of the frame, the scan line driver is to select the scan line connected to the pixel circuit in synchronization with an initiation timing of each sub frame and the data line driver is to supply the data signal to the pixel circuit based on a state of the sub frame corresponding to the initiation timing.
